(19) United States
(12) Patent Application Publication
(10) Pub. No.: US 2026/0310379 A1
(43) Pub. Date: Oct. 8, 2026

(54) Recognition-Physics Cascade Engineered Phase-Change Energy Storage Devices and Methods

(71) Applicant: Jonathan Washburn, Austin, TX (US)

(72) Inventor: Jonathan Washburn, Austin, TX (US)

(21) Appl. No.: 19/638,923

(22) Filed: Apr. 3, 2026

Related U.S. Application Data
(60) Provisional application No. 63/784,097, filed on Apr. 6, 2025.

(51) Int. Cl. G06F 3/06

(52) U.S. Cl. CPC G06F 3/0655; G06F 3/0604; G06F 3/0673

(57) ABSTRACT

Storage devices, systems, and methods are disclosed in which a storage element is configured to occupy first and second states separated by an effective switching barrier selected to correspond to a target operating regime. The target operating regime can be associated with write conditions, retention behavior, switching speed, release behavior, or energy-storage function. The storage element can comprise a molecular switching material, a phase-change film, a doped region, a nanoparticle structure, a thermal-storage composite, or a hybrid material system. A control arrangement can apply write, read, erase, or refresh stimuli to transition the storage element between states and determine a present state. Arrays, thermal modules, and design and fabrication methods are also disclosed for selecting materials and device structures to achieve target barrier regimes.

### CROSS-REFERENCE TO RELATED APPLICATIONS

This application claims the benefit of U.S. Provisional Patent Application No. 63/784,097, filed on Apr. 6, 2025, and titled “Recognition Physics-Cascade Engineered Molecular Phase-Change Energy Storage Devices.” The foregoing application is incorporated herein by reference to the extent permitted and to the extent that no subject matter incorporated by reference is inconsistent with the present disclosure.

### BACKGROUND

The present disclosure relates to energy storage devices, memory devices, and controllably bistable material systems, and more particularly to phase-change, molecular, nanoscale, solid-state, and hybrid storage architectures engineered according to a cascade-based barrier-selection framework that permits selection, tuning, and operation of metastable physical states for storing energy or information.

A wide range of conventional storage technologies rely on physical transitions between distinguishable states. Examples include latent-heat thermal storage materials, amorphous-to-crystalline phase-change materials, conformationally switchable molecules, redox-active compounds, ferroelectric materials, magnetic materials, semiconductor trap-based elements, and optically addressable nanoscale structures. In many such systems, a usable storage function depends on the existence of at least two distinguishable states separated by an energy barrier that is high enough to suppress undesired spontaneous decay, yet low enough to permit controlled writing, erasing, switching, or release under practical operating conditions.

In practice, conventional approaches often encounter difficult tradeoffs among retention time, switching speed, write energy, thermal stability, cycling endurance, integration compatibility, and device-to-device reproducibility. A material platform that switches rapidly may suffer from poor long-term retention. A platform engineered for deep retention may require excessive write energy, elevated temperatures, long switching intervals, or specialized interfaces that complicate scaling and manufacturability. Similar tradeoffs arise in thermal storage systems, where a desired storage density, release profile, or operating temperature window may be difficult to obtain simultaneously with repeatable cycling performance and acceptable fabrication cost.

Conventional material development has therefore often depended heavily on empirical screening, iterative trial-and-error optimization, or narrow platform-specific heuristics. In many cases, a designer begins with a candidate material and then measures whether the material exhibits acceptable barrier height, switching threshold, retention behavior, or thermal response. This approach can be slow and resource intensive, particularly where many possible molecular scaffolds, dopants, defect configurations, film thicknesses, nanoparticle sizes, matrix environments, or electrode geometries must be evaluated before arriving at a workable design.

Additional difficulties arise when attempting to translate a target system-level requirement into a realizable material or device architecture. For example, a designer may know a desired write wavelength, retention interval, threshold voltage, release temperature, switching time, or storage density, yet still lack a reliable framework for selecting a corresponding barrier regime and then mapping that barrier regime onto a practical material platform. This problem becomes more acute where the same general storage concept is intended to span multiple implementation classes, such as single-molecule devices, molecular ensembles, polymer films, quantum dots, doped semiconductors, thin-film stacks, cross-point arrays, or macro-scale thermal modules.

There is accordingly a need for devices, systems, and methods that enable storage-element design to proceed from a target barrier regime or target operating behavior toward a material, structural, and operational implementation, rather than relying solely on undirected screening. There is also a need for a unified framework capable of relating retention behavior, switching conditions, state stability, and barrier selection across different classes of phase-change and bistable systems, including molecular, optical, electrical, thermal, electrochemical, magnetic, and hybrid embodiments.

The present disclosure addresses these and other needs by providing a cascade-engineered recognition-physics framework for selecting, tuning, fabricating, and operating storage elements and related systems having first and second states separated by a barrier chosen to correspond to a selected operating regime. In various embodiments, the disclosed framework can be used to engineer storage devices for electrical energy storage, thermal energy storage, optical switching, non-volatile memory, volatile memory, semi-volatile memory, archival storage, multi-state storage, and related applications.

### SUMMARY

In one aspect, the present disclosure provides a storage device comprising at least one storage element having a first state and a second state separated by an effective switching barrier, wherein the effective switching barrier is selected according to a cascade-based barrier-selection framework to correspond to a target operating regime associated with a desired write condition, retention behavior, switching speed, release profile, or combination thereof. In various embodiments, the storage element can comprise a molecular system, a molecular ensemble, a polymeric material, a crystalline material, an amorphous material, a doped semiconductor structure, a nanoparticle structure, a quantum-confined structure, a phase-change thin film, a composite storage medium, or a hybrid material system.

In another aspect, the present disclosure provides a method of designing a storage device, the method comprising selecting a target performance parameter, determining a target barrier corresponding to the target performance parameter, selecting a cascade index or corresponding operating point associated with the target barrier, identifying a candidate material or structural configuration capable of exhibiting an effective switching barrier corresponding to the target barrier, and configuring the candidate material or structural configuration into a storage element operable to reversibly or controllably transition between at least two distinguishable states.

In another aspect, the present disclosure provides a method of fabricating a storage device by selecting a material class, composition, geometry, confinement dimension, dopant profile, defect profile, film thickness, matrix environment, interface structure, or combination thereof so that an effective switching barrier of the fabricated device corresponds to a target barrier associated with a selected operating regime. In some embodiments, fabrication can include synthesis, deposition, patterning, annealing, quenching, encapsulation, electrode integration, optical coupling, thermal coupling, or calibration operations.

In another aspect, the present disclosure provides a method of operating a storage device by applying a write stimulus selected to induce a transition of a storage element from a first state to a second state across an engineered barrier, sensing the state of the storage element using a read stimulus that is non-destructive or substantially non-destructive relative to the stored state, and optionally applying an erase stimulus, refresh stimulus, or release stimulus to return the storage element to the first state or to another selected state. Depending on the embodiment, the stimulus can be optical, electrical, thermal, electrochemical, magnetic, mechanical, strain-based, pressure-based, or a combination thereof.

In another aspect, the present disclosure provides an array or system comprising a plurality of storage elements arranged in a memory architecture, thermal-storage architecture, photonic architecture, sensor-integrated architecture, or controller-coupled architecture, wherein the storage elements are selected or tuned according to the disclosed barrier-selection framework. In some embodiments, the array or system further comprises addressing circuitry, selector devices, heating elements, optical-routing components, read circuitry, calibration circuitry, environmental sensors, or a controller configured to adjust operating conditions based on measured device behavior.

In another aspect, the present disclosure provides a controller or design engine configured to receive one or more target parameters including desired write energy, write wavelength, threshold voltage, switching time, retention interval, operating temperature, energy density, or application class, and to determine from the target parameters a corresponding target barrier, cascade index, material recommendation, device architecture, fabrication recipe, write condition, read condition, erase condition, or combination thereof. In some embodiments, the controller further uses measured device data to recalibrate operating conditions, compensate for drift, or classify a storage element into a selected retention or switching regime.

In some embodiments, the disclosed framework is applied to bistable systems satisfying a balanced recognition-cost condition associated with a cascade relation and a reciprocal-stability relation that support formation of first and second metastable states separated by an engineered barrier. In some embodiments, the barrier is selected according to the relation Delta_E_n=E_coh*X_opt\hat{ }(1-n), where Delta_E_n is a target barrier associated with a selected cascade index n, E_coh is a coherence-scale energy parameter, and X_opt is an optimization parameter. In some embodiments, the optimization parameter is related to phi and pi according to X_opt=phi/pi, where phi=(1+sqrt(5))/2.

In some embodiments, a target cascade index n_star is selected from a desired target barrier Delta_E_target according to the relation n_star=log(Delta_E_target/(E_coh*X_opt))/log(1/X_opt), optionally subject to calibration, rounding, tolerance selection, efficiency correction, or experimentally determined adjustment. In some embodiments, estimated retention behavior is associated with a relation of the form tau_ret=tau_base*exp(Delta_E_n/(k_B*T)), where tau_ret is an estimated retention time, tau_base is a base timescale parameter, k_B is Boltzmann's constant, and T is temperature.

In some embodiments, write conditions are selected from the target barrier. For example, an optical write wavelength can be estimated according to lambda_write=h*c/Delta_E_n, and an electrical write threshold can be estimated according to V_write=Delta_E_n/(q*eta_coupling), where h is Planck's constant, c is the speed of light, q is elementary charge, and eta_coupling is a coupling efficiency parameter. In some embodiments, an effective device-level write energy, density, or release profile is determined using one or more correction factors associated with packing fraction, active-element count, dissipation, interface coupling, or measurement calibration.

In some embodiments, the disclosed devices operate as volatile storage elements, semi-volatile storage elements, non-volatile storage elements, archival storage elements, thermal storage elements, optical switching elements, or multi-state storage elements, depending on the selected barrier regime and implementation platform. In some embodiments, the first and second states comprise conformational states, crystalline states, amorphous states, charge-localized states, charge-delocalized states, spin states, excitonic states, redox states, ferroelectric states, magnetic states, thermally loaded states, or combinations thereof.

These and other features, aspects, and advantages of the present disclosure will become apparent from the following description, drawings, and claims.

### BRIEF DESCRIPTION OF THE DRAWINGS

FIG. 1 is a schematic cross-sectional view of an exemplary phase-change storage device.

FIG. 2 is a flow diagram of an exemplary design method for selecting a target barrier and corresponding material platform.

FIG. 3 is a schematic energy landscape illustrating first and second metastable states separated by a switching barrier.

FIG. 4 is a chart showing barrier magnitude as a function of selected cascade index.

FIG. 5 is a schematic of an exemplary molecular switching element having first and second molecular states.

FIG. 6 is a cross-sectional view of an exemplary thin-film storage stack.

FIG. 7 is a schematic plan view of an addressable storage array.

FIG. 8 is a schematic of an optical actuation and readout system.

FIG. 9 is a timing diagram showing representative write, read, and erase pulses.

FIG. 10 is a process flow for fabricating and tuning a storage device to a target barrier.

FIG. 11 is a schematic of an exemplary thermal storage module.

FIG. 12 is a block diagram of an exemplary controller and design engine.

### DETAILED DESCRIPTION

The present disclosure provides devices, systems, materials, and methods for storing energy or information by controllably establishing, maintaining, and switching between distinguishable physical states separated by an engineered barrier. In various embodiments, the disclosed subject matter can be implemented using molecular systems, molecular ensembles, polymeric media, crystalline materials, amorphous materials, phase-change films, doped semiconductor structures, quantum-confined structures, nanoparticle structures, composite storage media, thermal-storage media, and hybrid architectures that exhibit at least two distinguishable states with different storage, transport, optical, thermal, electrical, electrochemical, magnetic, or structural characteristics.

In the present disclosure, a storage element can refer to any structure, material region, molecular unit, ensemble, device layer, particle, lattice region, phase region, or composite portion capable of occupying at least a first state and a second state that are distinguishable by one or more measurable properties. Depending on the embodiment, the measurable property can include electrical resistance, capacitance, current response, threshold voltage, optical absorption, reflectance, emission, refractive index, polarization response, thermal content, heat-release profile, magnetic response, structural ordering, conformational state, charge distribution, excitonic occupancy, redox state, or combinations thereof.

As used herein, a first state and a second state need not be limited to purely binary logical states, but instead can correspond to any two distinguishable physical conditions separated by a barrier sufficient to permit controlled occupancy and controlled transition behavior. In some embodiments, the first state and the second state are metastable states. In some embodiments, one of the states is a lower-energy state and the other is a higher-energy state. In some embodiments, both states are locally stable under expected operating conditions for a selected time interval. In some embodiments, additional intermediate or auxiliary states can also exist, provided that the device remains operable to store, release, or represent energy or information through controlled state occupancy.

As used herein, a phase can refer broadly to a physical state, organizational state, conformational state, structural state, charge state, spin state, optical state, thermal-loading state, or other distinguishable state of a storage element, whether or not the state corresponds to a classical bulk thermodynamic phase boundary. Thus, phase-change behavior in the present disclosure can include, by way of example, crystalline-to-amorphous transitions, amorphous-to-crystalline transitions, solid-solid transformations, conformational rearrangements, orbital or charge localization transitions, redox transitions, excitonic transitions, spin-crossover transitions, ferroelectric switching, magnetic switching, ion-distribution changes, defect-state reconfiguration, thermal loading and unloading states, and related state changes.

As used herein, an effective switching barrier can refer to an energy barrier, free-energy barrier, activation barrier, apparent barrier, or functionally equivalent threshold quantity associated with transitioning a storage element from one state to another under selected operating conditions. In some embodiments, the effective switching barrier can be determined analytically, estimated computationally, inferred from measured switching data, inferred from temperature dependence, inferred from spectroscopic data, inferred from calorimetric data, inferred from transport data, or established through a calibration procedure. In some embodiments, the effective switching barrier corresponds substantially to a target barrier selected according to the cascade-based framework disclosed herein.

As used herein, substantially corresponds can mean exactly matches, approximately matches, falls within a selected tolerance band, falls within a manufacturing tolerance band, falls within a calibration-adjusted tolerance band, falls within a confidence interval, or otherwise produces the intended functional behavior for the selected application. In some embodiments, substantially corresponds means within less than 50 percent of a target value. In some embodiments, substantially corresponds means within less than 25 percent of a target value. In some embodiments, substantially corresponds means within less than 10 percent of a target value. In some embodiments, substantially corresponds means within a tolerance selected according to device class, fabrication variability, environmental conditions, or intended retention regime.

In some embodiments, for memory-class devices and addressable storage arrays, “substantially corresponds” is satisfied when a measured effective switching barrier ΔE_eff falls within ±25% of a selected target barrier ΔE_target, unless a different tolerance band is selected by a stored calibration table or controller policy for a particular device class.

As used herein, a “target operating regime” refers to an operating class defined by one or more objective performance parameters selected from: (i) a write stimulus threshold (e.g., write energy, write fluence, threshold voltage, threshold current), (ii) a retention interval at a specified temperature, (iii) a switching time or delay-to-switch under a specified stimulus, and/or (iv) an energy-release temperature window or release profile for thermal embodiments.

In some embodiments, the target operating regime is specified by at least (i) a target barrier value or barrier band and (ii) at least one acceptance criterion selected from: threshold window, retention window, or switching-time window.

As used herein, “substantially corresponds” means that a measured effective switching barrier ΔE_eff (or an inferred barrier class) falls within a predetermined tolerance band around a target barrier ΔE_target, wherein the tolerance band is selected based on device class and manufacturing variability. In some embodiments, substantially corresponds means within ±50%; in some embodiments within ±25%; in some embodiments within ±10%.

In some embodiments, ΔE_eff is extracted from temperature-dependent switching or retention measurements by fitting measured threshold, delay-to-switch, or decay behavior to an activation model to obtain an inferred barrier, and the inferred barrier is compared to ΔE_target to determine whether the storage element satisfies the target operating regime.

In some embodiments, the disclosed devices are designed according to a cascade-based barrier-selection framework in which a target barrier is selected from a family of barrier values associated with a cascade index. In some embodiments, the target barrier is selected to correspond to a desired write condition, read condition, erase condition, retention interval, switching speed, thermal operating window, release profile, or energy-density target. In some embodiments, the target barrier is selected before a material platform is finalized, thereby allowing device design to proceed from a desired functional operating regime toward a practical material, structure, and operating recipe.

In some embodiments, a target barrier Delta_E_n can be selected according to the relation Delta_E_n=E_coh*X_opt\hat{ }(1-n), where E_coh is a coherence-scale energy parameter, X_opt is an optimization parameter, and n is a selected cascade index. In some embodiments, X_opt is related to phi and pi according to X_opt=phi/pi, where phi=(1+sqrt(5))/2. In some embodiments, the disclosed relations are used as design relations for identifying target barrier regimes, estimating physical operating windows, and selecting candidate material platforms capable of exhibiting corresponding effective switching barriers.

In some embodiments, a target cascade index n_star associated with a desired target barrier Delta_E_target is estimated according to the relation n_star=log(Delta_E_target/(E_coh*X_opt))/log(1/X_opt). In some embodiments, the value n_star can be rounded, truncated, ceiling-adjusted, floor-adjusted, tolerance-adjusted, calibration-adjusted, or otherwise processed to obtain a selected integer or non-integer operating point. In some embodiments, the selected operating point is used directly. In some embodiments, the selected operating point is used to define a target barrier band rather than a single exact barrier value.

In some embodiments, retention behavior can be estimated according to the relation tau_ret=tau_base*exp(Delta_E_n/(k_B*T)), where tau_ret is a retention time, tau_base is a base timescale parameter, k_B is Boltzmann's constant, T is temperature, and Delta_E_n is a selected target barrier or effective switching barrier. In some embodiments, the relation is used to classify an embodiment as volatile, semi-volatile, non-volatile, archival, or thermally buffered. In some embodiments, retention calculations are used comparatively, rather than as a strict prediction of exact measured lifetime, to select between candidate device regimes or candidate material platforms.

In some embodiments, an optical write condition can be estimated from the selected barrier according to the relation lambda_write=h*c/Delta_E_n, where lambda_write is an estimated write wavelength, h is Planck's constant, c is the speed of light, and Delta_E_n is the selected barrier. In some embodiments, an electrical write threshold can be estimated according to the relation V_write=Delta_E_n/(q*eta_coupling), where V_write is an estimated threshold voltage, q is elementary charge, and eta_coupling is an electrical, optical, thermal, or effective coupling efficiency parameter. In some embodiments, the estimated values are subsequently corrected based on calibration data, device geometry, packing fraction, dissipative losses, interface losses, local field enhancement, active-element count, or measured device response.

In some embodiments, the relations disclosed herein are used as design-selection relations and are not required to predict exact measured operating values without calibration. A selected target barrier can be mapped to a device-level effective switching barrier through one or more correction factors associated with coupling efficiency, active volume, active-element count, interface losses, local field enhancement, dissipative loss, packing fraction, measurement geometry, or environmental conditions. In some embodiments, a device-level write energy is estimated according to E_write_device=(N_active*Delta_E_eff)/eta_write, where N_active is a number of actively switched regions or elements, Delta_E_eff is an effective barrier contribution associated with the device implementation, and eta_write is a write-efficiency factor. In some embodiments, an effective barrier is represented as Delta_E_eff=Delta_E_n*C_corr, where C_corr is a calibration factor determined from measured device behavior. In this manner, the disclosed framework is used to guide material and device selection while allowing implementation-specific calibration for practical operation.

In some embodiments, the disclosed framework is applied to systems having first and second metastable states associated with a balanced recognition-cost condition and a reciprocal stability relation. In some embodiments, the reciprocal relation is represented by J(x)=0.5*(x+1/x)−1, where x is a scale ratio or operating ratio. In some embodiments, the relation is used to identify or characterize paired states having balanced occupancy or balanced switching behavior. In some embodiments, the first and second states form a dual-lock pair separated by an engineered barrier selected according to the cascade framework.

The disclosed framework can be used with physical systems spanning multiple implementation classes. For example, the storage element can be a switchable molecule, a molecular ensemble distributed in a host matrix, a polymer film, a thin-film stack, a semiconductor region, a defect-engineered lattice region, a nanoparticle, a quantum dot, an ion-storage region, a ferroelectric region, a magnetic region, a thermal-storage medium, or a hybrid structure combining two or more of the foregoing. In each case, the physical embodiment can be selected, tuned, and operated so that an effective switching barrier or effective release barrier corresponds to a target barrier associated with a selected operating regime.

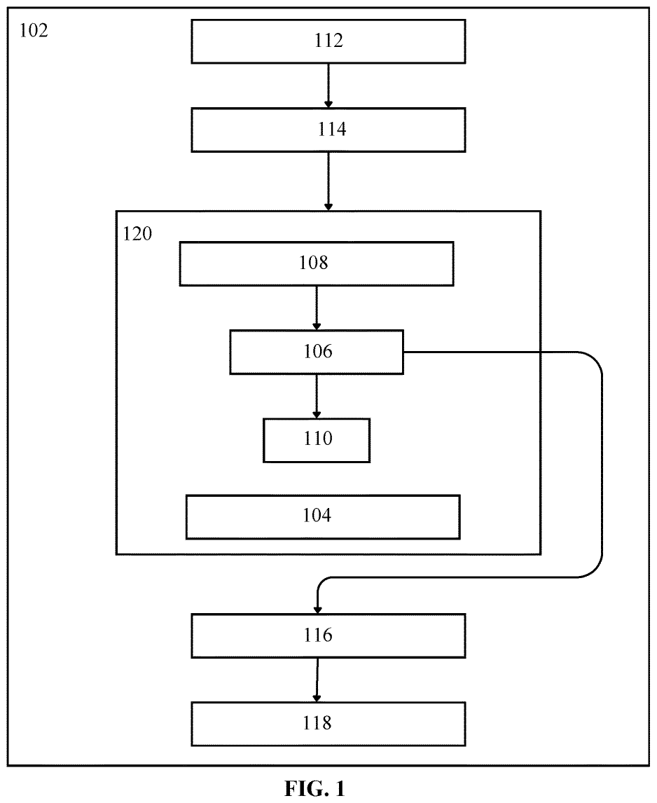

Turning now to the drawings, FIG. 1 is a schematic cross-sectional view of an exemplary phase-change storage device 102. In the illustrated embodiment, the storage device 102 includes a substrate 104 supporting an active phase-change element 106 positioned between an upper electrode 108 and a lower electrode 110. A controller 112 is coupled to a write source 114 and a read circuit 116, and the read circuit 116 can provide an output line 118 indicative of the state of the active phase-change element 106. In some embodiments, the storage device 102 further includes a package or encapsulation 120 configured to protect the active phase-change element 106 from contamination, oxidation, moisture, uncontrolled heat exchange, or undesired mechanical disturbance.

The substrate 104 can comprise any suitable support structure, including silicon, glass, sapphire, ceramic, flexible polymer, composite sheet, metal-backed laminate, or another mechanically supporting and thermally compatible material. In some embodiments, the substrate 104 further supports one or more alignment structures, dielectric layers, isolation regions, reflective layers, optical-routing layers, thermal-routing layers, or interconnect structures. In some embodiments, the substrate 104 is selected to improve thermal stability, electrical isolation, fabrication compatibility, optical accessibility, mechanical flexibility, or packaging integration.

The active phase-change element 106 can comprise any material or structure capable of occupying at least two distinguishable states separated by an engineered barrier. In some embodiments, the active phase-change element 106 comprises a molecular switching material. In some embodiments, the active phase-change element 106 comprises a polymeric storage material. In some embodiments, the active phase-change element 106 comprises a phase-change thin film, a chalcogenide material, a crystalline-amorphous switching medium, a doped semiconductor region, a defect-engineered lattice region, a nanoparticle ensemble, a quantum-confined structure, a thermal-storage composite, or a hybrid material system. In some embodiments, the active phase-change element 106 is selected or tuned so that its effective switching barrier substantially corresponds to a target barrier selected according to the cascade-based design framework disclosed herein.

The upper electrode 108 and the lower electrode 110 can comprise conductive layers, transparent conductive layers, patterned metal regions, semiconductor contacts, graphene layers, conductive oxides, or other coupling structures configured to deliver a write stimulus, sense a read response, collect charge, establish a field, generate Joule heating, or otherwise interact with the active phase-change element 106. In some embodiments, one or both of the upper electrode 108 and the lower electrode 110 are omitted in favor of optical coupling structures, thermal coupling structures, magnetic coupling structures, electrochemical coupling structures, or mixed coupling structures, depending on the implementation platform.

In some embodiments, the coupling structures associated with the active phase-change element 106 are selected according to the intended actuation modality of the device. Thus, an electrical implementation can use conductive electrodes, an optical implementation can use optical coupling structures, a thermal implementation can use local heater or thermal-routing structures, a magnetic implementation can use field-generating structures, and an electrochemical implementation can use biasing or ionic-coupling structures. In some embodiments, the same active phase-change element 106 is operable with more than one coupling modality.

The controller 112 can be implemented as any suitable control circuitry, processor-based system, state machine, programmable logic device, analog front-end, mixed-signal control module, or distributed control arrangement configured to select write conditions, read conditions, erase conditions, refresh conditions, calibration conditions, or combinations thereof. In some embodiments, the controller 112 uses one or more target performance parameters to determine a target barrier, a corresponding cascade index, a write pulse profile, a read pulse profile, an erase pulse profile, or a classification of the active phase-change element 106 into a selected operating regime. In some embodiments, the controller 112 also compensates for drift, temperature variation, cycle history, environmental exposure, manufacturing variation, or state-classification uncertainty. The write source 114 can provide a stimulus sufficient to induce a transition of the active phase-change element 106 from a first state to a second state or from the second state to the first state. In some embodiments, the write source 114 comprises an optical source configured to supply photons having a wavelength selected according to a target barrier. In some embodiments, the write source 114 comprises a voltage source, current source, pulse generator, heater driver, laser driver, optical modulator, electrochemical bias source, magnetic field source, strain actuator, pressure actuator, or combinations thereof. In some embodiments, the write source 114 produces a write condition selected from a calculated or calibrated threshold associated with the selected barrier regime.

The read circuit 116 can be configured to determine the present state of the active phase-change element 106 without causing substantial unintended switching. In some embodiments, the read circuit 116 measures resistance, current, capacitance, impedance, optical transmission, optical reflection, optical emission, polarization response, thermal response, magnetic response, spectroscopic response, or another state-indicative parameter. In some embodiments, the read circuit 116 operates at a read level below a write threshold. In some embodiments, the read circuit 116 uses a differential measurement, lock-in measurement, pulsed sampling approach, time-gated approach, or spectrally selective approach to distinguish the stored state while minimizing read disturb.

In operation, the storage device 102 can be programmed into a selected state by applying a write stimulus from the write source 114 through or toward the active phase-change element 106. The programmed state can then be retained for a selected interval determined in part by the effective switching barrier of the active phase-change element 106 and by the operating temperature and environment. The state can subsequently be determined by the read circuit 116, and in some embodiments the state can be reset, erased, refreshed, or driven into another selected state by further operation of the controller 112 and the write source 114. In this manner, the storage device 102 can function as a volatile storage element, a semi-volatile storage element, a non-volatile storage element, an archival storage element, a thermal-storage element, or a controlled energy-release element, depending on the selected barrier regime and implementation platform.

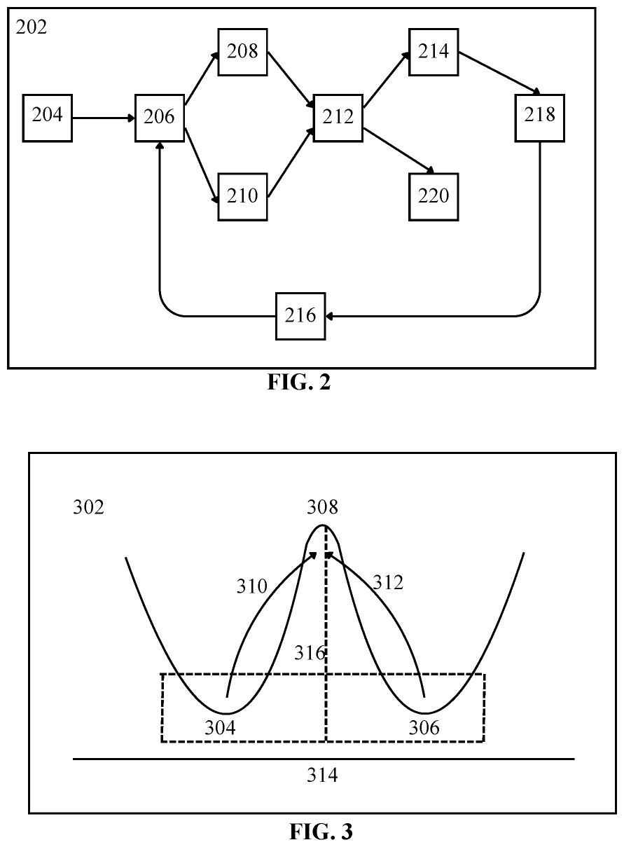

Although FIG. 1 illustrates a single active phase-change element 106 between an upper electrode 108 and a lower electrode 110, the disclosed subject matter is not limited to that arrangement. In some embodiments, multiple active phase-change elements 106 can be stacked, tiled, distributed laterally, distributed vertically, coupled in series, coupled in parallel, or organized into arrays. In some embodiments, one or more selector elements, dielectric isolation regions, thermal confinement regions, optical cavities, waveguides, sensors, local heaters, or feedback elements can be included. In some embodiments, the active phase-change element 106 is integrated into a memory array, a photonic routing system, a thermal buffer module, a sensing platform, or a computing architecture. FIG. 2 is a flow diagram of an exemplary design workflow 202 for selecting a target barrier and corresponding material platform. In the illustrated embodiment, a target specification input 204 is provided to a barrier-selection engine 206, which cooperates with an eigenmode index calculator 208 to identify a desired operating point. A material library 210 supplies candidate materials, structures, or compositions to a candidate selector 212. A fabrication recipe output 214 is then generated and can be evaluated by a characterization loop 216 to produce a verified design output 218 and, in some embodiments, a controller parameter output 220. Although shown as separate functional blocks, one or more of the components of the design workflow 202 can be combined, distributed, iteratively revisited, or implemented in software, hardware, or mixed form.

The target specification input 204 can include one or more desired performance parameters such as target write energy, target write wavelength, threshold voltage, threshold current, switching time, retention interval, release temperature, operating temperature range, cycle life, energy density, areal density, volumetric density, application class, packaging constraint, environmental constraint, fabrication compatibility parameter, or combinations thereof. In some embodiments, the target specification input 204 further includes allowable tolerances, preferred material classes, excluded material classes, preferred stimulus types, or cost or manufacturability constraints. In some embodiments, the design workflow 202 operates from a single dominant target parameter. In some embodiments, the design workflow 202 solves a multi-parameter optimization problem.

The barrier-selection engine 206 can determine a target barrier from one or more target specification inputs 204. In some embodiments, the barrier-selection engine 206 applies the relation Delta_E_n=E_coh*X_opt\hat{ }(1-n) or a calibrated, corrected, tolerance-adjusted, or implementation-specific derivative thereof. In some embodiments, the barrier-selection engine 206 determines a barrier band rather than a single value. In some embodiments, the barrier-selection engine 206 applies one or more efficiency corrections, geometry corrections, packing corrections, interface corrections, or empirical calibration factors to convert an ideal target barrier into a device-level target barrier. In some embodiments, the barrier-selection engine 206 ranks multiple candidate barrier regimes for later comparison.

The eigenmode index calculator 208 can determine a cascade index or operating point corresponding to a selected target barrier. In some embodiments, the eigenmode index calculator 208 computes n_star according to n_star=log(Delta_E_target/(E_coh*X_opt))/log(1/X_opt). In some embodiments, the eigenmode index calculator 208 determines a nearest index, a bracketing pair of indices, a tolerance window of indices, or a non-integer operating point associated with a calibration-adjusted operating region. In some embodiments, the eigenmode index calculator 208 classifies the selected operating point as corresponding to a volatile, semi-volatile, non-volatile, archival, or thermal-storage regime.

The material library 210 can include candidate molecules, molecular families, polymers, thin films, crystalline materials, amorphous materials, doped materials, defect-engineered materials, nanoparticle structures, quantum dots, composites, thermal-storage media, and hybrid systems. In some embodiments, entries in the material library 210 are associated with measured or estimated parameters including transition energy, apparent barrier, ionization energy, electron affinity, bandgap, HOMO-LUMO gap, confinement energy, ligand-field splitting, redox potential, crystallization temperature, glass-transition temperature, thermal conductivity, environmental stability, electrode compatibility, optical absorption band, or combinations thereof. In some embodiments, the material library 210 further stores fabrication recipes, known coupling conditions, known failure modes, and measured calibration data.

The candidate selector 212 can identify one or more candidate material or structural configurations likely to exhibit an effective switching barrier corresponding to the selected barrier regime. In some embodiments, the candidate selector 212 ranks candidate materials by barrier proximity. In some embodiments, the candidate selector 212 ranks candidate materials by expected write accessibility, retention performance, fabrication complexity, endurance, environmental stability, package compatibility, or combinations thereof. In some embodiments, the candidate selector 212 selects a material platform and also selects one or more tuning variables such as thickness, particle size, dopant concentration, anneal profile, matrix composition, contact geometry, optical coupling condition, thermal isolation condition, or encapsulation strategy.

The fabrication recipe output 214 can specify a material identity, composition, molecular scaffold, precursor set, deposition route, synthesis route, patterning step, annealing step, quenching step, encapsulation step, electrode structure, optical coupling structure, heater structure, device geometry, calibration step, or combinations thereof. In some embodiments, the fabrication recipe output 214 also specifies operating conditions such as write wavelength, write pulse length, write pulse energy, threshold voltage, threshold current, read level, erase level, refresh interval, retention test protocol, or temperature-compensation settings.

The characterization loop 216 can be used to verify whether a fabricated or proposed structure actually exhibits the selected barrier regime and desired device behavior. In some embodiments, the characterization loop 216 measures switching threshold, retention behavior, optical response, electrical response, thermal response, magnetic response, spectroscopic response, structural transition behavior, cycling behavior, drift, or environmental sensitivity. In some embodiments, measured data from the characterization loop 216 is fed back to revise the barrier-selection engine 206, the eigenmode index calculator 208, the material library 210, the candidate selector 212, or the fabrication recipe output 214. In some embodiments, the characterization loop 216 can reclassify a candidate device into a different barrier regime than originally predicted.

The verified design output 218 can comprise a confirmed device design, a confirmed material selection, a confirmed barrier range, a confirmed write and read recipe, a production-ready specification, or a classification label for subsequent deployment. In some embodiments, the controller parameter output 220 comprises thresholds, pulse widths, wavelengths, duty cycles, gain settings, calibration tables, temperature-compensation tables, drift-compensation tables, state classifiers, or combinations thereof, for use by a controller in the finished device. In this manner, the design workflow 202 allows the disclosed framework to be implemented not only as an abstract design tool, but also as a practical device-development and deployment pathway.

The design workflow 202 can be implemented entirely before fabrication, entirely after fabrication, iteratively during fabrication, or continuously during device deployment. In some embodiments, the design workflow 202 is used to select a molecular candidate before synthesis. In some embodiments, the design workflow 202 is used to tune a thin-film recipe. In some embodiments, the design workflow 202 is used to bin finished devices into different operating classes. In some embodiments, the design workflow 202 is used during in-field operation to update controller settings for drift compensation, environmental compensation, or aging compensation.

FIG. 3 is a schematic energy landscape 302 illustrating a first state 304 and a second state 306 separated by a switching barrier 308. A write path 310 can drive the storage element from the first state 304 toward the second state 306, and an erase path 312 can drive the storage element from the second state 306 toward the first state 304. In some embodiments, the first state 304 and the second state 306 are selected to satisfy a balance condition 314 associated with a reciprocal stability relation, such that spontaneous escape from either state is reduced within an intended operating window. In some embodiments, a spontaneous-decay suppression region 316 corresponds to a selected barrier range that provides functional retention for a desired application.

The energy landscape 302 of FIG. 3 can represent a molecular transition, a structural transition, a charge-distribution transition, a redox transition, a spin transition, a thermal-loading transition, a crystalline-amorphous transition, or another change between distinguishable physical states. In some embodiments, the horizontal dimension of the energy landscape 302 represents a generalized configuration coordinate rather than a literal spatial axis. In some embodiments, the vertical dimension represents energy, free energy, apparent activation energy, or another barrier-related quantity. The schematic nature of FIG. 3 is intended to show that the disclosed framework can be applied across different physical implementations even where the microscopic origin of the state transition differs from one embodiment to another.

In some embodiments, the first state 304 and the second state 306 are selected so that each state corresponds to a locally stable or metastable occupancy condition within a selected environmental range. In some embodiments, the states are approximately balanced. In some embodiments, one state is intentionally favored under quiescent conditions and the other state is accessed during writing, loading, or programming. In some embodiments, the state preference changes with temperature, field, illumination, pressure, local environment, or device history. In some embodiments, the disclosed controller logic compensates for such state-preference changes during operation.

The switching barrier 308 can be associated with a target barrier selected according to the cascade relation Delta_E_n=E_coh*X_opt\hat{ }(1-n), or with a corresponding calibrated device-level barrier. In some embodiments, the barrier is engineered by selecting a molecular scaffold, film composition, dopant population, confinement dimension, interface geometry, matrix environment, lattice condition, or thermal coupling pathway. In some embodiments, the barrier is additionally adjusted by changing local field concentration, contact spacing, shell thickness, packing fraction, strain state, or anneal history. Thus, the barrier shown schematically in FIG. 3 can be viewed as a practical design target rather than merely a descriptive property measured after the fact.

The write path 310 can correspond to any suitable stimulus sufficient to induce switching across the barrier 308. In some embodiments, the write path 310 corresponds to optical excitation using a wavelength selected from the target barrier. In some embodiments, the write path 310 corresponds to an electrical pulse selected to generate direct field-induced switching, carrier injection, or local Joule heating. In some embodiments, the write path 310 corresponds to thermal loading, electrochemical biasing, magnetic-field application, or mechanical or strain-based actuation. In some embodiments, the erase path 312 is the reverse of the write path 310. In some embodiments, the erase path 312 uses a different stimulus modality than the write path 310.

The balance condition 314 can be associated with a reciprocal recognition relation represented in some embodiments by J(x)=0.5*(x+1/x)−1, where x is a scale ratio, state ratio, or normalized operating ratio. In some embodiments, the relation is used to identify pairs of states that are sufficiently balanced to support reversible or selectively controllable operation. In some embodiments, the relation is applied directly during design. In some embodiments, the relation is applied indirectly through a precomputed library, lookup table, controller algorithm, or calibrated parameter set. In some embodiments, the relation is used to distinguish viable state pairs from unstable or overly asymmetric candidate transitions.

The spontaneous-decay suppression region 316 can correspond to a barrier regime in which spontaneous switching is sufficiently unlikely over a target retention interval at a selected temperature. In some embodiments, the target retention interval is less than one second. In some embodiments, the target retention interval is at least one minute. In some embodiments, the target retention interval is at least one day. In some embodiments, the target retention interval is at least one year. In some embodiments, the target retention interval is at least ten years. In some embodiments, the same material platform can be configured into different retention classes by changing thickness, geometry, confinement, matrix environment, or write/erase protocol.

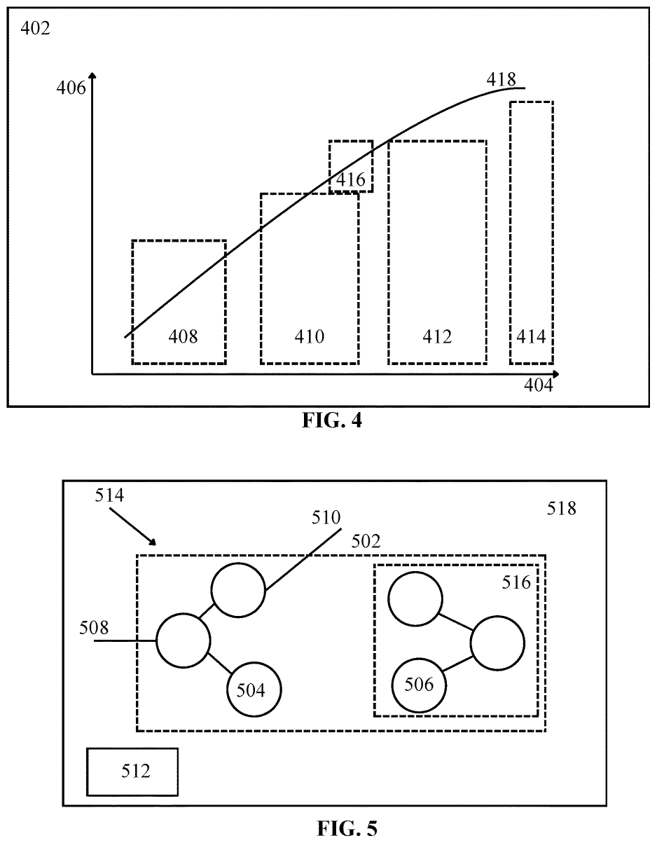

FIG. 4 is a chart 402 showing barrier magnitude as a function of selected cascade index. The chart 402 includes an index axis 404 and a barrier axis 406. In the illustrated concept, the barrier values can be grouped into a volatile region 408, a non-volatile region 410, an archival region 412, and a thermal-buffer region 414. A selected operating point 416 can be positioned within one of these regions, and a tolerance band 418 can define an acceptable range of barrier values or effective device behaviors around the selected operating point 416. The chart 402 is schematic and is intended to illustrate the design utility of mapping device regimes to barrier classes.

In some embodiments, lower selected barriers correspond to the volatile region 408, where switching can occur rapidly and stored states may decay over comparatively short intervals. Intermediate selected barriers can correspond to the non-volatile region 410, where stored states are retained over application-useful periods while remaining writable under practical conditions. Higher selected barriers can correspond to the archival region 412, where state persistence is increased and write operations may use stronger or more specialized stimuli. In some embodiments, a selected barrier range also corresponds to a thermal-buffer region 414 in which the controlled loading and unloading of thermal energy becomes a principal device function.

The selected operating point 416 can be determined from a target write wavelength, target threshold voltage, target switching time, target retention time, target release temperature, target energy density, or other application-specific parameter. In some embodiments, the selected operating point 416 corresponds to an integer cascade index. In some embodiments, the selected operating point 416 corresponds to a non-integer operating location between two discrete cascade indices and is implemented using a calibrated material or structural adjustment. In some embodiments, the selected operating point 416 corresponds to a band rather than a single point, allowing different devices or subpopulations within a manufacturing lot to satisfy the desired performance requirement.

The tolerance band 418 can be selected according to fabrication variability, environmental variability, controller capability, intended market, or application class. In some embodiments, a wider tolerance band 418 is acceptable for thermal-storage or sensor-buffer applications. In some embodiments, a narrower tolerance band 418 is selected for high-endurance memory or precision photonic applications. In some embodiments, the tolerance band 418 is asymmetric around the selected operating point 416, such as where a write-energy ceiling or retention minimum drives one side of the allowable range more strongly than the other.

In some embodiments, the chart 402 is generated analytically from the relation Delta_E_n=E_coh * X_opt\hat{ }(1-n). In some embodiments, the chart 402 is generated from measured device populations or from a calibrated model that maps ideal cascade barriers to device-level effective barriers. In some embodiments, the chart 402 further includes overlays associated with estimated write wavelength, threshold voltage, release temperature, energy density, or cycle life. In some embodiments, the chart 402 is implemented as part of a controller interface, design software interface, material-screening tool, or production-classification tool.

FIG. 5 is a schematic of an exemplary molecular switching element 502 having a first molecular state 504 and a second molecular state 506. In the illustrated embodiment, the molecular switching element 502 can include a linker 508, one or more substituent groups 510, an electrode contact 512, an optical excitation path 514, a readout interaction region 516, and a surrounding matrix 518. The arrangement shown in FIG. 5 is schematic and can represent a single molecule, a localized molecular cluster, or a molecular population distributed within a host environment.

The molecular switching element 502 can comprise any molecule or molecular family capable of occupying at least two distinguishable states separated by an effective switching barrier. In some embodiments, the first molecular state 504 and the second molecular state 506 correspond to different conformations. In some embodiments, the states correspond to different isomeric forms, different tautomeric forms, different redox states, different orbital occupancy conditions, different ligand-field states, different spin states, or different coupled charge and structural states. In some embodiments, the molecular switching element 502 comprises a diarylethene-type scaffold, an azobenzene-type scaffold, a spiropyran or merocyanine-type scaffold, a rotaxane-type scaffold, a catenane-type scaffold, an organometallic complex, a donor-acceptor conjugated system, or another switchable molecular architecture.

The linker 508 can couple the molecular switching element 502 to a surface, matrix, contact, electrode, nanoparticle, polymer chain, framework structure, or neighboring molecular unit. In some embodiments, the linker 508 is selected to improve charge transport, optical coupling, mechanical anchoring, or environmental stability. In some embodiments, the linker 508 is omitted. In some embodiments, multiple linkers 508 are used. The substituent group 510 can be selected to tune steric effects, conjugation length, electron density, charge transfer, local polarity, host compatibility, solubility, packing behavior, crystallization tendency, or barrier magnitude.

The electrode contact 512 can provide electrical coupling for writing, reading, or state stabilization. In some embodiments, the electrode contact 512 is a direct contact to a single molecule or small molecular ensemble. In some embodiments, the electrode contact 512 is an electrode contacting a matrix containing many molecular switching elements 502. In some embodiments, the electrode contact 512 is replaced or supplemented by an optical or thermal interface. The optical excitation path 514 can be configured to deliver photons at a selected wavelength or wavelength band associated with the target barrier or with a state-selective transition of the molecular switching element 502.

The readout interaction region 516 can correspond to a portion of the molecular switching element 502 or surrounding environment from which the stored state is sensed. In some embodiments, the readout interaction region 516 is associated with a measurable difference in absorption, fluorescence, Raman response, conductivity, capacitance, polarization response, refractive index, or magnetic signature between the first molecular state 504 and the second molecular state 506. In some embodiments, readout is performed optically. In some embodiments, readout is performed electrically. In some embodiments, two or more modalities are combined to improve state-discrimination confidence.

The surrounding matrix 518 can comprise a polymer host, a solid-state host, a solvent environment, a gel, a porous framework, a self-assembled monolayer environment, a crystalline lattice environment, or another structure configured to position, stabilize, isolate, or couple the molecular switching element 502. In some embodiments, the surrounding matrix 518 influences the effective switching barrier by altering polarity, dielectric constant, steric restriction, thermal transport, excitonic quenching, charge mobility, local packing, or environmental exposure. In some embodiments, the surrounding matrix 518 is selected or tuned as an active part of the barrier-engineering process rather than as a passive carrier.

In some embodiments, a molecular implementation is designed by first selecting a target barrier regime and then identifying a molecular scaffold, substituent pattern, matrix environment, and coupling condition that collectively produce an effective switching barrier corresponding to the target regime. In some embodiments, the molecular implementation is verified by spectroscopy, current-voltage measurement, cycling analysis, temperature-dependent switching analysis, or retention testing. In some embodiments, the molecular implementation is configured for use as a non-volatile memory element, a volatile optical switch, a low-energy programmable sensor element, or a thermal or chemical stimulus recorder.

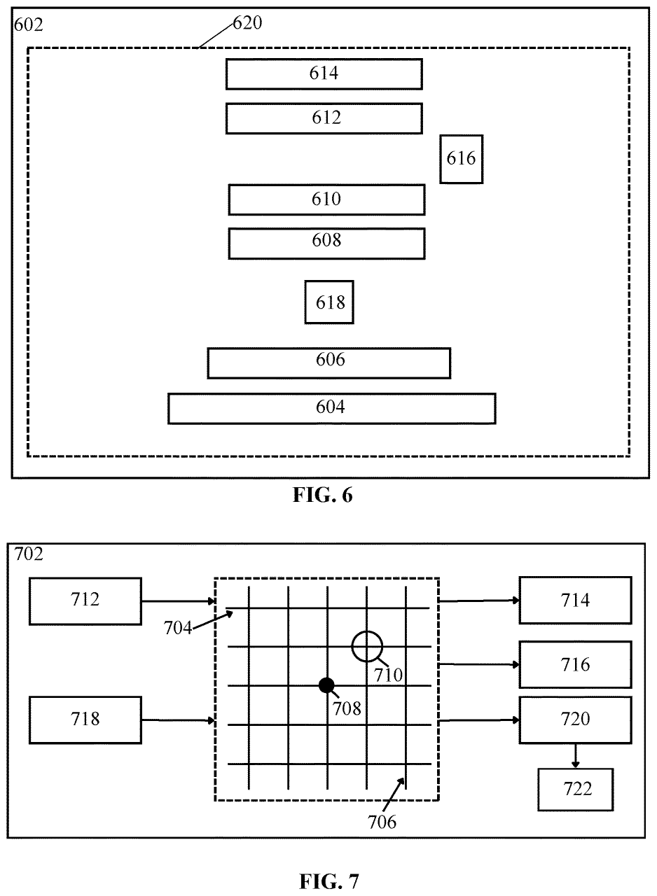

FIG. 6 is a cross-sectional view of an exemplary thin-film storage stack 602. In the illustrated embodiment, the stack 602 includes a substrate 604, a lower conductor 606, an interface or adhesion layer 608, an active phase-change film 610, an upper conductor 612, an encapsulation layer 614, a contact via 616, a local heater region 618, and a dielectric isolation region 620. Although depicted schematically as a layered stack, the arrangement can be modified for planar, vertical, recessed, patterned, or three-dimensional architectures.

The active phase-change film 610 can comprise a chalcogenide material, an oxide material, a mixed-valence material, a doped semiconductor film, a polymeric switching film, a ferroelectric film, a magnetic switching film, a layered two-dimensional material, a perovskite-derived material, a composite phase-change medium, or another film capable of occupying at least two distinguishable states separated by an effective barrier. In some embodiments, the distinguishable states correspond to crystalline and amorphous states. In some embodiments, the distinguishable states correspond to different local ordering conditions, charge configurations, defect configurations, redox conditions, or phase fractions.

The lower conductor 606 and the upper conductor 612 can provide write, erase, or read access to the active phase-change film 610. In some embodiments, one or both conductors comprise metals, conductive oxides, semiconductor layers, transparent conductive materials, graphene, carbon-based conductors, or multilayer conductor stacks. In some embodiments, the conductors are patterned to concentrate fields, control thermal distribution, reduce sneak currents, improve readout linearity, or support array integration. In some embodiments, one conductor is omitted where optical-only, thermal-only, or hybrid access is used.

The interface or adhesion layer 608 can promote film uniformity, crystal orientation, adhesion, diffusion control, electrical contact quality, thermal boundary control, or defect management. In some embodiments, the interface or adhesion layer 608 is selected to alter the effective switching barrier of the active phase-change film 610 by changing local strain, nucleation behavior, interface dipole, or heat extraction rate. In some embodiments, multiple interface layers are used. In some embodiments, the interface or adhesion layer 608 is omitted.

The local heater region 618 can be configured to supply or localize heat during writing, erasing, resetting, or release operations. In some embodiments, the local heater region 618 comprises a resistive heater, a Joule-heating bottleneck, a phase-localized constriction, a photothermal absorber, or another local energy-delivery structure. In some embodiments, switching is field-driven and the local heater region 618 is optional. In some embodiments, both field-driven and thermally assisted mechanisms are used. The dielectric isolation region 620 can reduce parasitic current, reduce thermal cross-talk, define active area, or improve array selectivity.

In some embodiments, the thin-film storage stack 602 is engineered by selecting film composition, stoichiometry, thickness, grain structure, dopant population, defect density, anneal profile, quench profile, interface composition, conductor geometry, or local heater geometry so that the effective switching barrier of the active phase-change film 610 substantially corresponds to a target barrier associated with a selected operating regime. In some embodiments, the stack 602 is optimized for non-volatile memory. In some embodiments, the stack 602 is optimized for fast switching. In some embodiments, the stack 602 is optimized for thermal buffering or controlled release.

FIG. 7 is a schematic plan view of an addressable storage array 702. In the illustrated embodiment, word lines 704 and bit lines 706 intersect to define storage-cell locations at which storage cells 708 are positioned. In some embodiments, each storage cell 708 is associated with a selector element 710. A controller 712 can coordinate operation of the array 702, and a sense amplifier 714, a write driver 716, a row decoder 718, and a column decoder 720 can support addressing and state determination, with a data output 722 providing retrieved information. The array 702 can be implemented as a cross-point array, tiled architecture, hierarchical banked array, or another addressable arrangement.

Each storage cell 708 can include any storage element disclosed herein, including molecular elements, thin-film phase-change elements, doped lattice regions, quantum-confined structures, thermal-storage subcells, or hybrid active regions. In some embodiments, different storage cells 708 within the same array 702 are fabricated identically. In some embodiments, different storage cells 708 are intentionally fabricated with different barrier classes to support different retention or response behaviors within a common platform. In some embodiments, one portion of the array 702 is optimized for volatile operation and another portion is optimized for non-volatile operation.

The selector element 710 can comprise a diode, transistor, threshold switch, access device, non-linear resistor, optically gated switch, thermally gated switch, or another component configured to reduce unintended access, reduce sneak paths, localize write energy, or improve read selectivity. In some embodiments, the selector element 710 is integrated with the storage cell 708. In some embodiments, the selector element 710 is omitted. In some embodiments, array addressing is achieved optically, thermally, or magnetically rather than through line-based electrical selection. The controller 712 can coordinate barrier-aware operation across the array 702. In some embodiments, the controller 712 stores per-cell calibration values, threshold corrections, temperature-compensation values, drift-compensation values, or wear-history values. In some embodiments, the controller 712 assigns different write pulse widths, write amplitudes, read levels, or refresh intervals to different storage cells 708 based on measured barrier differences. In some embodiments, the controller 712 bins storage cells 708 into operating classes and allocates them to different uses based on their measured or estimated retention characteristics.

The sense amplifier 714 and write driver 716 can be adapted to the selected read and write modality. In some embodiments, the sense amplifier 714 measures current, resistance, capacitance, optical response, thermal response, or another state-indicative parameter. In some embodiments, the write driver 716 generates electrical pulses, optical excitation sequences, heater drive patterns, electrochemical bias profiles, or hybrid actuation signals. The row decoder 718 and the column decoder 720 can coordinate selection of individual storage cells 708, groups of storage cells 708, or subarrays for reading, writing, erasing, refreshing, or calibration.

In some embodiments, the array 702 is used as a memory architecture. In some embodiments, the array 702 is used as an energy-buffer architecture. In some embodiments, the array 702 is used as a sensor-integrated architecture in which a local environmental stimulus changes the state of selected storage cells 708 and the changed state is later read out. In some embodiments, the array 702 is used in neuromorphic, probabilistic, or adaptive computing applications in which different storage cells 708 are intentionally configured with different barriers, switching probabilities, or decay behaviors.

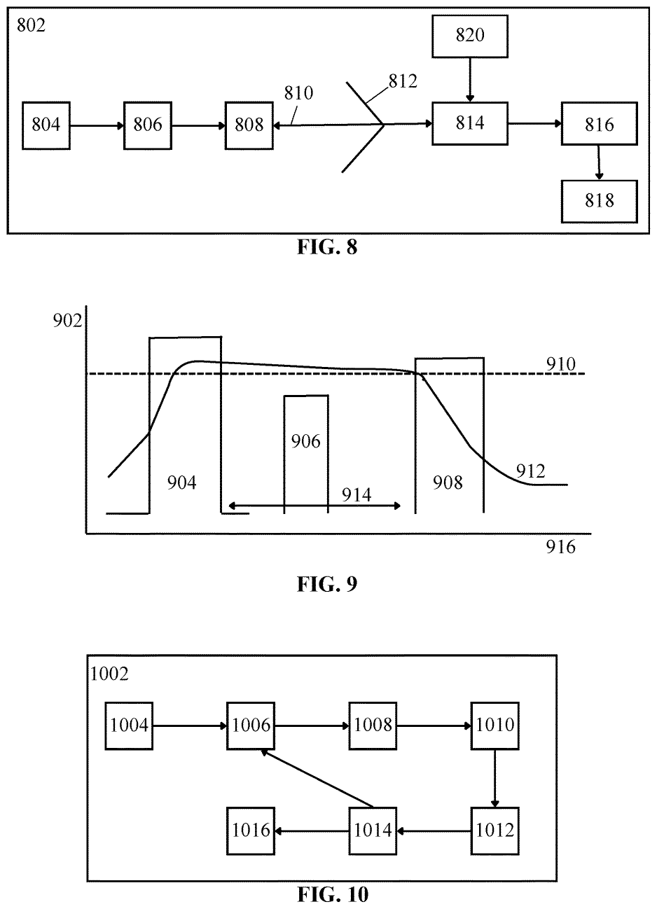

FIG. 8 is a schematic of an optical actuation and readout system 802. In the illustrated embodiment, the optical actuation and readout system 802 includes a light source 804, a wavelength selector 806, a modulator 808, a beam path 810, a focusing optic 812, a target device region 814, a detector 816, a read processor 818, and an erase source 820. Although shown schematically as a free-space arrangement, the optical actuation and readout system 802 can alternatively be implemented using waveguides, fiber-coupled components, integrated photonic structures, near-field delivery structures, or combinations thereof.

The light source 804 can comprise any source capable of delivering an optical write or read stimulus to the target device region 814. In some embodiments, the light source 804 is a laser. In some embodiments, the light source 804 is a light-emitting diode, supercontinuum source, tunable optical source, pulsed source, mode-locked source, or another coherent or incoherent emitter. In some embodiments, the wavelength selector 806 is configured to select a wavelength or wavelength band corresponding to a target barrier of a storage element. In some embodiments, the wavelength selector 806 comprises a filter, grating, prism, resonator, tunable cavity, acousto-optic device, electro-optic device, or software-controlled source-selection arrangement.

The modulator 808 can control one or more temporal, spectral, spatial, or intensity characteristics of the applied optical stimulus. In some embodiments, the modulator 808 controls pulse width, repetition rate, duty cycle, intensity, polarization, phase, beam position, or wavelength switching. In some embodiments, the modulator 808 is configured so that a write stimulus delivered through the beam path 810 is sufficient to induce switching of a selected storage element across an engineered barrier, while a read stimulus is maintained below a destructive or state-altering threshold. In some embodiments, the same optical channel is used for both writing and reading. In some embodiments, different optical conditions are used for writing and reading.

The focusing optic 812 can direct the optical stimulus to the target device region 814 with a selected spot size, numerical aperture, depth of focus, or coupling profile. In some embodiments, the focusing optic 812 comprises one or more lenses, mirrors, diffractive elements, waveguide couplers, metasurfaces, photonic-crystal structures, or plasmonic structures. In some embodiments, the focusing optic 812 is selected to enhance local field intensity, improve addressing resolution, reduce cross-talk, or control penetration depth into the active region of the storage device.

The target device region 814 can correspond to a molecular storage element, a thin-film active region, a nanoparticle ensemble, a quantum-confined region, a thermal-storage subregion, or another storage element disclosed herein. In some embodiments, the optical write condition applied to the target device region 814 is selected according to the relation lambda_write=h*c/Delta_E_n, optionally with calibration, linewidth adjustment, intensity scaling, polarization control, or pulse-shape correction. In some embodiments, a wavelength band is selected rather than a single wavelength. In some embodiments, optical writing is resonant. In some embodiments, optical writing is non-resonant but sufficiently coupled to drive the desired state transition.

The detector 816 can receive an optical response from the target device region 814, and the read processor 818 can determine a stored state based on the detected response. In some embodiments, the detected response comprises transmission, reflection, fluorescence, phosphorescence, Raman scattering, absorption contrast, refractive-index change, polarization change, interferometric phase shift, thermal emission, or another optically discernible characteristic. In some embodiments, the read processor 818 uses time-gated analysis, spectral filtering, lock-in detection, differential comparison, threshold comparison, classifier-based analysis, or combinations thereof to determine whether the target device region 814 is in a first state or a second state.

The erase source 820 can provide an optical stimulus configured to return the storage element to a prior state or to another selected state. In some embodiments, the erase source 820 emits at a different wavelength than the light source 804. In some embodiments, the erase source 820 uses a broader spectrum, longer pulse duration, lower intensity, higher intensity, complementary polarization, or alternative temporal waveform to produce erasure or resetting. In some embodiments, erasure is performed thermally or electrically rather than optically, and the erase source 820 is omitted or replaced by another actuation structure.

The optical actuation and readout system 802 can be used in standalone devices, integrated photonic platforms, memory arrays, optical-routing architectures, remote or distributed sensor systems, or hybrid electro-optical systems. In some embodiments, the optical actuation and readout system 802 is used where electrical contacts are undesirable or impractical. In some embodiments, the optical actuation and readout system 802 enables state-selective addressing of individual storage regions within a larger device or array. In some embodiments, multiple light sources 804, multiple detectors 816, or multiple beam paths 810 are used in parallel.

FIG. 9 is a timing diagram 902 showing representative write, read, and erase operations. In the illustrated embodiment, a write pulse 904, a read pulse 906, and an erase pulse 908 are shown relative to a threshold level 910, a state-response trace 912, a retention interval 914, and a cycle counter 916. The timing diagram 902 is schematic and can represent optical, electrical, thermal, electrochemical, magnetic, mechanical, or hybrid operating sequences.

The write pulse 904 can be selected to exceed a transition condition associated with the effective switching barrier of the storage element. In some embodiments, the write pulse 904 is an electrical pulse having a selected amplitude, width, rise time, fall time, polarity, or pulse train structure. In some embodiments, the write pulse 904 is an optical pulse having a selected wavelength, intensity, pulse width, or repetition pattern. In some embodiments, the write pulse 904 is a thermal pulse, electrochemical bias profile, magnetic-field pulse, strain pulse, or pressure pulse. In some embodiments, multiple sub-threshold pulses are accumulated to achieve switching.

The read pulse 906 can be selected to determine the stored state while reducing or avoiding unintended switching. In some embodiments, the read pulse 906 is maintained below the threshold level 910. In some embodiments, the read pulse 906 is shorter than the write pulse 904. In some embodiments, the read pulse 906 uses a different modality than the write pulse 904. In some embodiments, the read pulse 906 is repeated multiple times and the resulting measurements are averaged or otherwise processed to improve confidence. In some embodiments, a read sequence includes a baseline measurement, a state-sensitive measurement, and a comparison operation. The erase pulse 908 can return the storage element to a prior state, to a reset state, or to another selected state. In some embodiments, the erase pulse 908 has opposite polarity relative to the write pulse 904. In some embodiments, the erase pulse 908 is longer in duration than the write pulse 904. In some embodiments, the erase pulse 908 is thermally dominated. In some embodiments, the erase pulse 908 comprises a wavelength different from that of the write pulse 904. In some embodiments, the erase pulse 908 is omitted in write-once or passive-release embodiments.

The threshold level 910 can represent a write threshold, switching threshold, release threshold, or effective actuation threshold. In some embodiments, the threshold level 910 is fixed for a given device class. In some embodiments, the threshold level 910 varies from cell to cell or from cycle to cycle. In some embodiments, the controller stores a calibrated threshold level 910 for each storage element or group of storage elements. In some embodiments, the threshold level 910 is dynamically compensated for temperature, drift, prior cycling, environmental exposure, or measured state uncertainty.

The state-response trace 912 can represent the evolution of a measurable state-indicative parameter during and after application of the write pulse 904, read pulse 906, or erase pulse 908. In some embodiments, the state-response trace 912 corresponds to resistance, optical contrast, thermal output, magnetic signature, charge state, capacitance, or another measurable quantity. In some embodiments, the state-response trace 912 exhibits abrupt switching. In some embodiments, the state-response trace 912 exhibits gradual evolution, partial programming, or multi-level response. In some embodiments, the state-response trace 912 is used by the controller for verify-and-adjust programming.

The retention interval 914 can correspond to the time during which the storage element remains in a selected state after writing and before substantial decay or resetting occurs. In some embodiments, the retention interval 914 is estimated from the relation tau_ret=tau_base*exp(Delta_E_n/(k_B * T)). In some embodiments, the retention interval 914 is measured empirically and stored in a calibration table. In some embodiments, the retention interval 914 depends on ambient temperature, self-heating, packaging, state asymmetry, barrier drift, or cumulative cycling effects. In some embodiments, the controller refreshes the storage element before the end of the expected retention interval 914.

The cycle counter 916 can represent the number of write-read-erase cycles or programming operations experienced by the storage element. In some embodiments, cycle history is used to adjust write conditions, threshold estimates, read margins, or refresh policy. In some embodiments, the cycle counter 916 is tracked at the device level, the subarray level, or the individual-cell level. In some embodiments, endurance behavior is improved by selecting barrier regimes, stimulus profiles, or material systems that reduce structural fatigue, interfacial damage, trapped-charge accumulation, or irreversible phase segregation.

FIG. 10 is a process flow 1002 for fabricating and tuning a storage device to a target barrier. In the illustrated embodiment, the process flow 1002 includes a precursor or material selection step 1004, a synthesis or deposition step 1006, a patterning step 1008, an anneal or tuning step 1010, a barrier measurement step 1012, a feedback adjustment step 1014, and a packaged-device output 1016. Although shown sequentially, one or more of these operations can be omitted, reordered, repeated, or performed in parallel depending on the implementation platform.

In the precursor or material selection step 1004, a material class, molecular scaffold, precursor set, host medium, dopant species, nanoparticle composition, film chemistry, or composite formulation can be selected based on a target barrier regime or target operating behavior. In some embodiments, the selection is made using the design workflow of FIG. 2. In some embodiments, the selection includes choosing one or more tuning parameters such as film thickness, particle radius, shell thickness, dopant concentration, ligand identity, matrix polarity, anneal temperature, or local heater geometry.

The synthesis or deposition step 1006 can include chemical synthesis, self-assembly, solution deposition, spin coating, dip coating, evaporation, sputtering, atomic layer deposition, chemical vapor deposition, printing, lamination, nanoparticle growth, ion implantation, or other fabrication techniques suitable for producing the selected active material or structure. In some embodiments, the synthesis or deposition step 1006 is used to form a molecular layer, a polymer film, a crystalline film, an amorphous film, a multilayer stack, a doped lattice region, a quantum-confined structure, or a thermal-storage composite.

The patterning step 1008 can define active areas, electrodes, contacts, heater structures, waveguides, optical access windows, confinement geometries, array architectures, encapsulation boundaries, or other device features. In some embodiments, the patterning step 1008 includes lithography, etching, lift-off, embossing, shadow masking, laser patterning, nanoimprint processing, printing, selective growth, or combinations thereof. In some embodiments, the patterning step 1008 is omitted for bulk materials, self-assembled structures, or unpatterned thermal-storage embodiments.

The anneal or tuning step 1010 can adjust structure and barrier properties after initial formation. In some embodiments, the anneal or tuning step 1010 includes thermal annealing, rapid thermal processing, quenching, optical conditioning, electrical conditioning, bias stressing, environmental exposure, solvent annealing, strain tuning, pressure tuning, or magnetic conditioning. In some embodiments, the anneal or tuning step 1010 is used to change crystallinity, defect population, phase fraction, interface structure, molecular packing, solvent content, charge distribution, ligand configuration, or stress state so that the effective switching barrier more closely corresponds to the target barrier.

The barrier measurement step 1012 can determine whether the fabricated structure exhibits the intended barrier regime. In some embodiments, the barrier measurement step 1012 includes threshold-voltage extraction, threshold-current extraction, retention testing, temperature-dependent switching analysis, spectroscopy, calorimetry, structural analysis, optical-response analysis, magnetic-response analysis, or combinations thereof. In some embodiments, the barrier measurement step 1012 directly estimates an effective switching barrier. In some embodiments, the barrier measurement step 1012 infers barrier class indirectly from measured operational behavior.

The feedback adjustment step 1014 can revise one or more fabrication or tuning parameters based on measured results from the barrier measurement step 1012. In some embodiments, the feedback adjustment step 1014 changes composition, thickness, anneal profile, matrix choice, contact geometry, optical coupling, heater power, or encapsulation conditions. In some embodiments, the feedback adjustment step 1014 reclassifies the device into a nearby acceptable barrier band instead of forcing the device toward a single nominal target. In some embodiments, the feedback adjustment step 1014 updates a design database or controller parameter set for later production or deployment.

The packaged-device output 1016 can comprise an individual storage cell, an array, a thermal-storage module, an optically addressable component, a sensor-integrated component, or another finished product. In some embodiments, the packaged-device output 1016 includes a controller parameter table, calibration data, classification data, drift-compensation data, or recommended operating conditions generated during or after fabrication. In some embodiments, the packaged-device output 1016 is subjected to further environmental screening, endurance testing, or application-specific qualification testing before deployment.

In some embodiments, barrier verification is performed by measuring switching threshold or state-decay behavior at multiple temperatures and fitting the measured behavior to an activation-based model to extract an effective switching barrier or barrier class. In some embodiments, optical switching probability, threshold voltage, threshold current, write fluence, delay-to-switch, retention time, or relaxation rate is measured as a function of temperature and compared to a selected target regime. In some embodiments, structural or spectroscopic measurements are used together with operational measurements to confirm that the intended state transition is present. In some embodiments, the resulting measured barrier classification is stored as calibration data for later device control, binning, or product assignment.

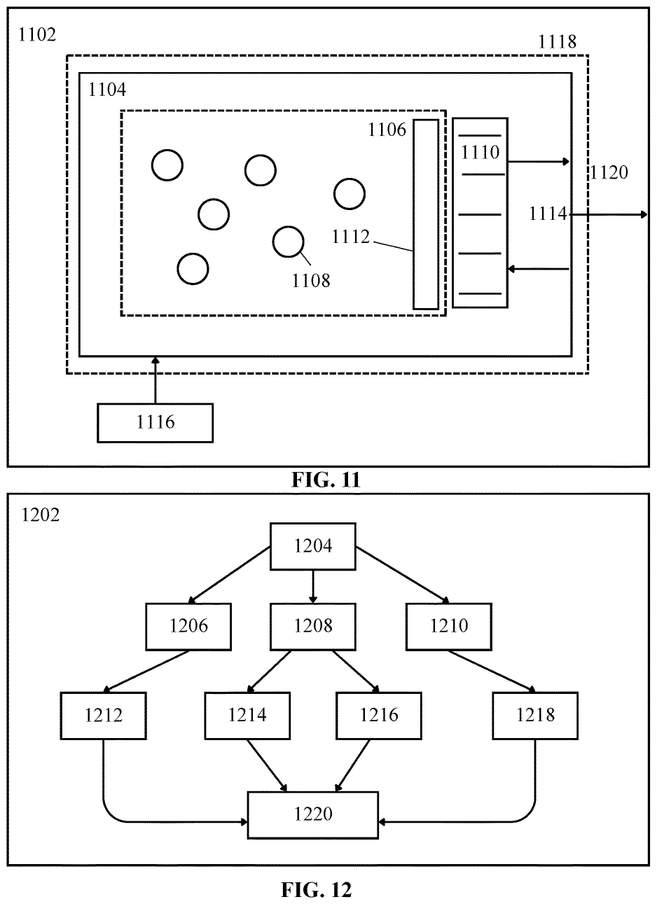

FIG. 11 is a schematic of an exemplary thermal module 1102. In the illustrated embodiment, the thermal module 1102 includes a housing 1104, a composite matrix 1106, active storage elements 1108, a heat exchanger 1110, a thermal interface 1112, a fluid path 1114, a controller or sensor 1116, an insulation region 1118, and a thermal output path 1120. The thermal module 1102 illustrates that the disclosed barrier-selection framework can be used not only for information storage, but also for controlled thermal-energy loading, retention, and release.

The active storage elements 1108 can comprise microencapsulated phase-change particles, molecular storage media, solid-state phase-change inclusions, crystalline-amorphous switching media, doped storage particles, nanoparticle composites, or hybrid storage structures selected to have an effective loading or release barrier corresponding to a target thermal operating regime. In some embodiments, the active storage elements 1108 are dispersed within the composite matrix 1106. In some embodiments, the active storage elements 1108 are arranged in layers, channels, modules, or gradient structures within the housing 1104.

The composite matrix 1106 can provide structural support, thermal coupling control, environmental isolation, chemical compatibility, and spatial distribution of the active storage elements 1108. In some embodiments, the composite matrix 1106 comprises a polymer, ceramic, metal foam, carbon-based scaffold, gel, porous framework, cementitious medium, laminate, or another bulk carrier. In some embodiments, the composite matrix 1106 is selected to increase effective thermal conductivity. In some embodiments, the composite matrix 1106 is selected to reduce thermal leakage and prolong a desired retention interval.

The heat exchanger 1110 and the thermal interface 1112 can be configured to load thermal energy into the thermal module 1102 or extract thermal energy therefrom. In some embodiments, the fluid path 1114 carries a liquid or gas to exchange heat with the active storage elements 1108 through the heat exchanger 1110. In some embodiments, the heat exchanger 1110 is replaced or supplemented by direct conductive loading, radiant loading, electrical heating, photothermal loading, or passive environmental loading. In some embodiments, thermal release is controlled so that the thermal module 1102 provides a selected temperature window, a selected release rate, or a selected duration of useful output.

The controller or sensor 1116 can measure temperature, heat flux, loading state, release state, environmental conditions, or cycle history, and can adjust loading or release conditions accordingly. In some embodiments, the controller or sensor 1116 determines whether the active storage elements 1108 remain within a target barrier regime or target thermal window. In some embodiments, the insulation region 1118 is selected to reduce parasitic heat loss. In some embodiments, the thermal output path 1120 is directed to a building space, battery pack, electronics enclosure, garment, medical device, transport container, industrial process stream, or another thermal load.

In some embodiments, the thermal module 1102 is engineered by selecting active storage elements 1108 whose effective barrier or phase-transition regime corresponds to a desired charge temperature, discharge temperature, retention time, release rate, cycle life, or energy density. In some embodiments, the thermal module 1102 is used in building-temperature regulation. In some embodiments, the thermal module 1102 is used in battery thermal management. In some embodiments, the thermal module 1102 is used in electronics cooling, textiles, medical temperature management, cold-chain logistics, or industrial heat buffering.

FIG. 12 is a block diagram of an exemplary controller and design engine 1202. In the illustrated embodiment, the controller and design engine 1202 includes a processor 1204, a memory 1206, a barrier engine 1208, a material database 1210, a pulse-synthesis module 1212, a sensor input 1214, a calibration module 1216, a user interface 1218, and a network interface 1220. The controller and design engine 1202 can be implemented as on-device control circuitry, external design software, a cloud-based optimization platform, or a hybrid distributed architecture.

The processor 1204 can execute instructions stored in the memory 1206 to determine target barriers, select cascade indices, compute write or read conditions, classify devices, compensate for drift, or otherwise implement the disclosed framework. In some embodiments, the memory 1206 stores equations, lookup tables, calibration tables, material records, state-classification logic, temperature-compensation logic, cycle-history data, and device-specific parameters. In some embodiments, the barrier engine 1208 computes one or more target barriers from user-supplied or system-supplied performance requirements.

The material database 1210 can store candidate material families, compositions, device architectures, fabrication variables, measured barrier data, measured switching data, retention classifications, environmental stability data, and recommended operating conditions. In some embodiments, the material database 1210 is updated during development or field deployment as new measured data becomes available. In some embodiments, the pulse-synthesis module 1212 generates electrical, optical, thermal, electrochemical, magnetic, or mechanical actuation profiles selected for a given barrier class or device type.

The sensor input 1214 can receive data from temperature sensors, optical detectors, electrical monitors, magnetic sensors, environmental sensors, cycle counters, health monitors, or other sensing elements. In some embodiments, the calibration module 1216 uses sensor data to update threshold estimates, retention estimates, state-discrimination margins, or write and erase conditions. In some embodiments, the calibration module 1216 reclassifies a device or cell into a different operating regime based on measured drift or aging.

The user interface 1218 can receive target performance inputs, design constraints, selected application types, operating preferences, or manual override commands. In some embodiments, the user interface 1218 displays barrier maps, candidate materials, predicted write wavelengths, threshold voltages, retention estimates, temperature windows, fabrication recipes, or diagnostic information. In some embodiments, the network interface 1220 communicates with external databases, fabrication equipment, monitoring systems, supervisory controllers, or remote update services.

In some embodiments, the controller and design engine 1202 is used during pre-fabrication design to identify a candidate material platform. In some embodiments, the controller and design engine 1202 is used during fabrication to adjust process settings. In some embodiments, the controller and design engine 1202 is used after deployment to control writing, reading, erasing, refreshing, thermal loading, thermal release, or predictive maintenance. In some embodiments, the controller and design engine 1202 provides closed-loop operation in which measured device behavior is continuously or periodically compared to a target barrier regime and operating conditions are adjusted accordingly. In some embodiments, the controller and design engine 1202 does not merely compute a target barrier or operating classification, but generates one or more concrete physical control outputs for a selected device implementation. Such outputs can include a write wavelength, a pulse amplitude, a pulse width, a duty cycle, a heater-drive level, a refresh interval, a read level, or an erase condition. In some embodiments, the generated control outputs are applied to physical actuation circuitry coupled to one or more storage elements so that the storage elements are written, read, erased, refreshed, thermally charged, or thermally discharged according to the selected operating regime. In some embodiments, measured readback data from the physical device is returned to the controller and used to revise subsequent control outputs.

Although FIGS. 1-12 illustrate representative embodiments and workflows, the disclosed subject matter is not limited to the exact structures, arrangements, sequences, or operating modes shown. Features disclosed with respect to one embodiment can be combined with features disclosed with respect to another embodiment unless incompatible. Likewise, a feature shown as a single component can be implemented as multiple components, and multiple components can be combined into a single component. The disclosed framework is therefore intended to support a broad range of material, device, system, and method implementations in which a controllable state transition is engineered according to a selected barrier regime.

In some embodiments, the disclosed storage elements are configured as molecular devices in which a selected molecular scaffold is chosen to provide first and second molecular states separated by an effective switching barrier corresponding to a selected barrier regime. A designer can begin by selecting a target write wavelength, threshold voltage, retention interval, switching speed, or operating temperature range, and can then determine a target barrier and corresponding cascade index. A molecular scaffold, substituent set, linker chemistry, and surrounding matrix can then be selected so that the resulting molecular device exhibits an effective switching barrier that substantially corresponds to the target barrier. In some embodiments, the molecular device is used as a single-element memory cell. In some embodiments, the molecular device is used as part of an ensemble, film, matrix, or optically addressed layer.

In some embodiments, the disclosed storage elements are configured as solid-state phase-change devices in which a film, stack, lattice region, or composite active region is selected and tuned according to the disclosed barrier-selection framework. A material composition, stoichiometry, thickness, defect profile, interface condition, and heater configuration can be selected to provide a target switching barrier and target write threshold. In some embodiments, the solid-state phase-change device is configured for resistive readout. In some embodiments, the solid-state phase-change device is configured for optical readout. In some embodiments, the solid-state phase-change device is configured for thermal loading and release rather than information storage.

In one illustrative thin-film implementation, the active region is formed as a patterned stack including a lower conductor, an active phase-change film, and an upper conductor, with an optional interface layer and an optional local heater region. A target threshold voltage, target switching time, and target retention interval are first selected. A target barrier regime is then identified, and a candidate film composition, film thickness, interface condition, and heater geometry are selected to place the device within the target regime. The stack is deposited, patterned, and annealed, after which switching threshold, retention behavior, and read-disturb behavior are measured. If the measured threshold is above a desired operating window, the active thickness, local heater geometry, or interface condition can be adjusted to increase coupling or local heating efficiency. If the measured retention is below a target window, the film composition, phase fraction, defect density, or anneal profile can be adjusted to increase the effective switching barrier.

In some embodiments, thin-film verification includes applying repeated write-read-erase cycles while measuring resistance, optical contrast, threshold drift, and retention at one or more temperatures. A candidate thin-film implementation can be accepted where the measured switching threshold, read margin, and state retention each fall within selected tolerances for the intended product class. A candidate implementation that does not satisfy a preferred non-volatile class can nevertheless be accepted for a volatile, semi-volatile, or thermal-buffer product class if its measured behavior corresponds to that adjacent operating regime.

In some embodiments, the disclosed storage elements are configured as nanoparticle, nanocluster, or quantum-confined systems in which a confinement dimension, shell structure, inter-particle spacing, host medium, or contact geometry is selected to provide a target barrier-associated state transition. In some embodiments, a nanoparticle radius, shell thickness, or confinement region is selected according to a relation associated with a target barrier. In some embodiments, an effective confinement dimension is estimated according to R_conf=hbar*pi/sqrt(2*m_eff*Delta_E_n), where R_conf is an effective confinement dimension, hbar is the reduced Planck constant, m_eff is an effective carrier mass, and Delta_E_n is a selected barrier. In some embodiments, the foregoing relation is used as a design estimate and is subsequently refined by calibration, spectroscopy, transport testing, or structural measurement.

In one illustrative nanoparticle implementation, a nanoparticle population is selected based on core composition, particle diameter, shell thickness, ligand identity, and host-matrix properties so that the resulting confinement-associated transition falls within a selected target barrier regime. The nanoparticles are incorporated into a matrix or between contacts, and switching behavior is evaluated using optical excitation, electrical biasing, or both. Measured readout can include absorption contrast, emission change, threshold current, threshold voltage, or time-dependent relaxation behavior. If the measured actuation threshold is too high, particle diameter, shell thickness, inter-particle spacing, local cavity enhancement, or contact spacing can be adjusted. If the measured retention is too low, shell structure, matrix choice, ligand selection, or environmental isolation can be adjusted to stabilize the selected state.

In some embodiments, a nanoparticle or quantum-confined implementation is screened by fabricating multiple populations having different confinement dimensions or shell configurations and measuring their state-transition behavior under a common operating protocol. Populations whose measured barrier-associated behavior falls within a selected tolerance band can be incorporated into memory cells, optical switching elements, event-recording devices, or thermal-storage composites. Populations falling outside a preferred class can be reclassified for another barrier regime rather than discarded.

In some embodiments, the disclosed storage elements are configured as doped or defect-engineered lattice systems. A host material, dopant species, dopant concentration, defect population, implantation profile, activation anneal condition, local field condition, and packaging arrangement can be selected to create first and second distinguishable lattice-associated states separated by an effective switching barrier corresponding to a selected barrier regime. In some embodiments, the distinguishable states correspond to charge-trapping configurations, defect-localization configurations, spin-associated states, local structural configurations, or coupled electronic and structural states. In some embodiments, the resulting device is integrated into an addressable array, a sensor, a thermal module, or a controller-supervised platform.

In one illustrative doped or defect-engineered implementation, a host material is selected together with a dopant species, implantation or incorporation profile, and post-formation activation condition so that the resulting structure exhibits first and second distinguishable states separated by an effective switching barrier corresponding to a selected target regime. The host region is formed, dopants or defect-forming species are introduced, and the structure is activated by annealing, electrical conditioning, optical conditioning, or combinations thereof. Switching behavior can then be characterized by threshold measurements, retention measurements, temperature-dependent measurements, or state-dependent transport measurements. If the measured threshold or retention differs from a desired class, the dopant concentration, defect density, local field geometry, activation condition, or packaging condition can be adjusted to move the device toward the selected regime.

In some embodiments, doped or defect-engineered implementations are used in persistent event-recording applications, non-volatile memory cells, threshold-triggered devices, or analog-decay sensing applications. In some embodiments, different defect populations within a common host are intentionally used to produce different barrier classes in different regions of the same device or array.

In some embodiments, the disclosed storage elements are configured as hybrid systems combining multiple physical mechanisms or multiple material classes. For example, a molecular switching species can be embedded in a solid-state host, a nanoparticle can be coupled to a molecular or polymeric matrix, a phase-change film can be integrated with a photonic resonator, or a thermal-storage composite can include electrically or optically addressable active inclusions. In such embodiments, the effective switching barrier can arise from one constituent, from a coupled transition between constituents, or from a device-level emergent response. The disclosed framework can still be applied by treating the hybrid system as having an effective barrier or effective transition regime associated with the intended operational behavior.

In some embodiments, write energy or device-level energy density is estimated using one or more correction factors associated with coupling efficiency, active-element count, packing fraction, dissipation, thermal leakage, or interface loss. By way of example, a device-level write energy can be estimated according to E_write_device=(N_active*Delta_E_eff)/eta_write, where N_active is the number of actively switched elements, Delta_E_eff is an effective device-level barrier contribution, and eta_write is a write-efficiency factor. In some embodiments, an effective density is estimated according to rho_device=(N_active*Delta_E_eff*f_pack)/V_device, where f_pack is a packing factor and V_device is a device volume. Such relations can be used to connect barrier engineering at the element level to practical device-level and module-level performance estimates.

In some embodiments, the effective device-level barrier differs from an ideal target barrier because of non-ideal coupling, interface losses, local field enhancement, statistical variation, environmental conditions, finite linewidth of the actuation source, heterogeneous packing, or parasitic pathways. Accordingly, the present disclosure contemplates use of correction terms, calibration factors, and experimentally derived mappings between ideal barrier values and measured effective switching thresholds. In some embodiments, an effective barrier is represented as Delta_E_eff=Delta_E_n * C_corr, where C_corr is a correction factor that can depend on device class, geometry, environment, operating mode, or fabrication history. In some embodiments, a correction factor is stored in a calibration table and updated over time.

In some embodiments, the disclosed framework is used to classify devices or storage elements into operating classes. A device or element can be classified as volatile where spontaneous decay occurs over relatively short intervals under nominal conditions, semi-volatile where the stored state persists over intermediate intervals, non-volatile where the stored state persists over application-useful intervals without active refresh, archival where the state persists over very long intervals under selected environmental conditions, or thermal-buffered where a principal function is controlled loading and release of thermal energy rather than binary information storage. In some embodiments, classification is based on an estimated retention time. In some embodiments, classification is based on measured retention performance. In some embodiments, classification is updated dynamically based on observed drift, aging, or environment.

In some embodiments, the disclosed devices support reversible switching between a first state and a second state. In some embodiments, switching is intentionally one-way, quasi-reversible, partially reversible, or resettable only under selected restorative conditions. In some embodiments, a device is operated in a write-once-read-many mode. In some embodiments, a device is operated in a repeatedly rewritable mode. In some embodiments, a device is configured for partial programming or analog-state programming, such that a measured state variable changes in a graded manner rather than switching between only two sharply discrete levels.

In some embodiments, the disclosed framework is used to implement multi-state storage even though the primary discussion above focuses on first and second states. A third state, fourth state, or additional intermediate states can be provided by selecting multiple barrier-associated operating points, by selecting multiple physical subregions, by partially programming a common active element, or by coupling multiple active mechanisms in a single device. In some embodiments, the read circuitry or optical processing distinguishes among three or more states. In some embodiments, the controller uses multiple thresholds or classification boundaries to assign the present device state. In some embodiments, the additional states correspond to different retention classes, different release profiles, or different analog weights.

In some embodiments, the disclosed devices are designed to operate over a selected temperature range. The target barrier can be selected in view of a worst-case temperature, nominal temperature, charge temperature, discharge temperature, storage temperature, or expected environmental profile. In some embodiments, the controller adjusts actuation thresholds based on measured temperature. In some embodiments, the packaging, substrate, insulation, interface structures, or surrounding matrix are selected to stabilize thermal behavior. In some embodiments, temperature is used intentionally as a write-assist, erase-assist, release-control, or state-selection variable.

In some embodiments, the disclosed devices are designed to operate under selected mechanical, optical, electromagnetic, or chemical environments. A storage element can be packaged or encapsulated to reduce moisture ingress, oxidation, contamination, mechanical disturbance, photobleaching, or undesired redox activity. In some embodiments, the environment is intentionally controlled to tune a barrier or state preference. For example, matrix polarity, ambient pressure, solvent content, local strain, magnetic field, or optical background can be selected or compensated to stabilize a desired state transition. In some embodiments, the controller records environmental conditions and adjusts its write, read, erase, or refresh policy accordingly.

In some embodiments, the disclosed framework is implemented as a method of designing a storage device. A target application is first identified, such as non-volatile memory, volatile switching, thermal buffering, optical routing, sensor recording, or analog-state storage. One or more target performance values are then selected, including write energy, write wavelength, threshold voltage, switching speed, retention interval, release temperature, cycle life, density, or operating environment. A target barrier or barrier range is then determined, optionally together with a target cascade index or target operating point. One or more candidate material systems and device architectures are then selected based on their ability to realize the target barrier regime. In some embodiments, the selected design is then fabricated, measured, and iteratively refined.

In some embodiments, the disclosed framework is implemented as a method of fabricating a storage device. A material class is selected, a structure is formed using synthesis or deposition, one or more interfaces or contacts are provided, and the resulting device is tuned through annealing, conditioning, calibration, or barrier verification. In some embodiments, tuning is repeated until the device falls within a selected tolerance band around a target barrier or target operational behavior. In some embodiments, devices that do not fall within a preferred nominal target are nevertheless assigned to an adjacent acceptable class and are used in a different product tier, different array region, or different operating mode.

In some embodiments, the disclosed framework is implemented as a method of operating a storage device. A write stimulus is selected according to a target barrier or measured threshold, a read stimulus is selected to distinguish the stored state while reducing unintended switching, and an erase or reset stimulus is selected where reversibility is desired. In some embodiments, the operating method further includes verify-and-adjust programming, temperature compensation, drift compensation, state-confidence scoring, error correction, refresh control, or reclassification of the storage element into a different operating regime. In some embodiments, the operating method includes use of multiple modalities, such as electrical writing with optical reading, optical writing with thermal erasing, or electrical writing with calorimetric release monitoring.

In some embodiments, the disclosed framework is implemented as a system-level architecture in which multiple storage elements are networked, tiled, banked, stacked, or otherwise integrated. Such a system can include memory arrays, photonic-routing architectures, thermal modules, sensor matrices, adaptive-computing structures, or distributed energy-buffer systems. In some embodiments, different elements within the same system are intentionally configured with different effective barriers to support multiple functions within one platform, such as short-term volatile buffering, long-term non-volatile retention, and deep-retention archival storage in different regions of the same device or module.

In some embodiments, the disclosed systems are used in computing platforms, mobile devices, data-storage systems, sensors, optical communication systems, thermal-management systems, textiles, building materials, transport containers, medical systems, industrial process-control systems, or defense and aerospace systems. In some embodiments, the disclosed systems are used where low-energy writing, high-density storage, thermal buffering, adaptive retention, optical addressability, or environment-responsive operation provides an advantage. In some embodiments, the same underlying barrier-engineering principles are used across different industries even though the material and packaging choices differ.

In one illustrative example, a molecular storage element is designed for optical writing and non-destructive optical readout. A target wavelength and retention interval are selected, from which a target barrier and target operating point are determined. A candidate molecular scaffold and host matrix are selected so that the first molecular state and second molecular state are separated by an effective switching barrier corresponding to the target barrier. The molecule or molecular ensemble is incorporated into a device region, exposed to a write wavelength sufficient to induce switching, and later read using a lower-intensity or spectrally distinct optical probe. In some embodiments, the stored state is erased by a complementary wavelength, a thermal reset, or an electrical bias.

In another illustrative example, a thin-film stack is designed for non-volatile information storage. A target threshold voltage, switching time, and retention interval are selected. A target barrier regime is then identified, and a film composition, thickness, interface layer, and local heater geometry are selected so that the effective switching barrier of the active film substantially corresponds to the target barrier regime. The stack is then fabricated, measured, and tuned until write, read, and erase behavior fall within a selected tolerance. In some embodiments, a population of such stacks is integrated into an addressable array and individually calibrated by a controller.

Example (electrical PCM cell). In one embodiment, a thin-film phase-change cell is designed for a target non-volatile retention class at temperature T_nom. A target retention interval τ_target and an allowed refresh interval are selected. A target barrier band is then selected such that ΔE_target≥k_B·T_nom·ln(τ_target/τ_base), where τ_base is a base timescale determined from device calibration. A write pulse is synthesized with amplitude V_write and width t_write sufficient to exceed the calibrated write threshold corresponding to the barrier band, and a verify read is applied using a read pulse below the write threshold. If the verify read fails the acceptance rule, one or more supplemental pulses are applied until the acceptance rule is met or a maximum pulse budget is reached.

In some embodiments, the verify read measures the state-indicative parameter at a predetermined time after the write pulse and compares the measured parameter to an acceptance criterion selected for a product class. In resistive-readout embodiments, the acceptance criterion can be R_high/R_low≥R_min; in optical-readout embodiments, the acceptance criterion can be ΔOD≥OD_min or reflectance ratio≥K_min. In some embodiments, the controller stores the acceptance criterion per cell or per group and updates the acceptance criterion based on measured drift, temperature variation, cycling history, or environmental exposure.

In some embodiments, the effective switching barrier ΔE_eff is extracted from temperature-dependent switching or retention measurements by fitting measured threshold, delay-to-switch, or decay behavior to an activation model to obtain an inferred barrier. The inferred barrier is compared to ΔE_target to determine whether the storage element satisfies a target operating regime, and if the inferred barrier does not satisfy the target operating regime the controller (or fabrication tuning process) adjusts at least one of a write pulse amplitude, write pulse width, coupling efficiency correction, thickness, confinement dimension, dopant profile, defect profile, matrix environment, or interface structure to move the device toward the target barrier band.

In another illustrative example, a thermal-storage module is designed for controlled release over a selected temperature window. A target charge temperature, discharge temperature, retention duration, and energy-density objective are selected. Active storage elements and a composite matrix are then chosen so that the loading and release behavior correspond to a selected thermal operating regime associated with a target barrier or phase-transition window. The resulting module is integrated with a heat exchanger and insulation structure and is operated under controller supervision to load heat, retain heat, and release heat in a controlled manner. In some embodiments, module-level calibration is performed using measured thermal response.

In another illustrative example, a controller-supervised system uses measured device data to update operating conditions over time. A storage element is initially classified into a selected barrier regime and programmed with an initial write threshold and read level. As the device experiences cycling, temperature excursions, or environmental exposure, sensor data and readback behavior are used to estimate drift in threshold or retention. The controller then updates the write pulse profile, read margin, erase condition, refresh policy, or classification label for that storage element. In this manner, the disclosed framework supports not only initial device design, but also adaptive lifecycle control.

The examples above are illustrative and are not intended to limit the scope of the disclosure. Features described in connection with one example can be combined with features of another example unless incompatible. Likewise, the equations, parameters, tolerances, calibration approaches, and device classes disclosed herein can be used individually or in combination. The present disclosure therefore encompasses not only the specific embodiments expressly described, but also modifications, equivalents, combinations, subcombinations, scaled implementations, and alternative operational regimes that fall within the spirit of the disclosed barrier-engineered storage framework.

In some embodiments, candidate materials are selected by comparing measured or estimated physical parameters to a target barrier regime before full device fabrication is undertaken. Such physical parameters can include ionization energy, electron affinity, bandgap, HOMO-LUMO gap, confinement energy, ligand-field splitting, redox potential, crystallization temperature, glass-transition temperature, melting behavior, thermal conductivity, dielectric constant, magnetic anisotropy, or combinations thereof. In some embodiments, one or more of these physical parameters is used as a proxy for expected switching accessibility, retention behavior, or environmental robustness. In some embodiments, the parameters are used together with measured calibration data to rank candidate materials for a selected application class.

In some embodiments, a candidate material is accepted where a measured or estimated effective switching barrier falls within a selected tolerance band around a target barrier. In some embodiments, the tolerance band is selected according to product tier, fabrication capability, or application sensitivity. In some embodiments, a broader tolerance band is acceptable for thermal buffering, event logging, or approximate analog-state applications. In some embodiments, a narrower tolerance band is selected for deterministic memory, photonic routing, or precision threshold-triggered systems. In some embodiments, devices outside a preferred tolerance band are discarded. In some embodiments, such devices are instead reclassified for use in a different operating regime.

In some embodiments, measured barrier behavior is extracted from temperature-dependent switching analysis. A device can be operated at multiple temperatures, and measured switching probabilities, switching delays, threshold values, retention times, or decay rates can be fit to an activation model to estimate an effective switching barrier. In some embodiments, the extracted barrier is compared to a target barrier generated from the disclosed cascade framework. In some embodiments, the extracted barrier is then used to revise a material ranking, a fabrication recipe, or a controller calibration table.

In some embodiments, measured barrier behavior is extracted from optical analysis. A material or device can be illuminated using one or more wavelengths while its state transition probability, spectral response, emission response, absorption response, or relaxation dynamics are measured. In some embodiments, resonant or near-resonant features are used to estimate an actuation energy associated with switching. In some embodiments, non-resonant optical loading behavior is also used to determine whether the selected storage element can be operated efficiently under available source conditions. In some embodiments, optical characterization is combined with electrical or thermal characterization to improve barrier estimation accuracy.

In some embodiments, measured barrier behavior is extracted from electrical analysis. A device can be subjected to one or more current sweeps, voltage sweeps, pulsed actuation sequences, impedance measurements, or transient measurements to determine threshold values, switching delays, endurance behavior, or state-dependent transport properties. In some embodiments, the measured electrical threshold is mapped to an effective barrier through a coupling model that accounts for local field concentration, Joule heating, charge injection, contact resistance, and interface losses. In some embodiments, the mapping is stored for later use by a controller or by a design engine.

In some embodiments, measured barrier behavior is extracted from thermal or calorimetric analysis. A storage material, composite, or module can be heated, cooled, charged, or discharged while thermal output, temperature evolution, latent-heat behavior, or release rate is monitored. In some embodiments, the resulting data is used to determine whether a selected thermal-storage embodiment satisfies a target charge temperature, target discharge temperature, target retention duration, or target energy-density objective. In some embodiments, the measured thermal behavior is mapped to a selected barrier regime or phase-transition window for later design reuse.

In some embodiments, the disclosed framework supports batch screening of many candidate materials or device variants. A population of samples can be fabricated with variations in composition, thickness, particle size, matrix composition, dopant concentration, anneal history, or contact geometry. Each sample can then be measured to determine one or more effective barrier indicators, and the samples can be ranked relative to a target operating regime. In some embodiments, machine learning, statistical modeling, or rule-based filtering is used to accelerate the ranking process. In some embodiments, the selected top-performing samples are then subjected to more detailed endurance, stability, or packaging studies.

In some embodiments, the disclosed framework supports binning of fabricated devices into multiple product classes. A first group of devices can be assigned to a volatile class, a second group to a semi-volatile class, a third group to a non-volatile class, and a fourth group to an archival or thermal-buffer class. In some embodiments, binning is performed at the wafer level, die level, module level, or individual-cell level. In some embodiments, binning improves manufacturing yield by allowing near-target devices to be used in applications suited to their measured barrier class rather than rejected outright.

In some embodiments, acceptance into a production class requires that a measured device satisfy at least a threshold write-accessibility condition, a threshold state-discrimination condition, and a threshold retention or release condition under one or more selected environmental test conditions. In some embodiments, acceptance criteria differ by product class, such that a memory-class device is evaluated using write threshold, read margin, and retention, whereas a thermal-buffer class is evaluated using loading temperature, release temperature, and release duration. In some embodiments, production binning is therefore performed according to functional barrier class rather than nominal composition alone.

In some embodiments, endurance is improved by selecting write and erase conditions that are sufficient to achieve state transition while reducing excess energy deposition. For example, a write pulse can be chosen with a minimum effective duration and amplitude needed to cross the effective switching barrier while reducing overshoot. In some embodiments, multi-step or shaped pulses are used. In some embodiments, verify-and-adjust programming is used so that each write operation is terminated once the intended state is confirmed. In some embodiments, such approaches reduce structural fatigue, thermal stress, trapped-charge accumulation, interface degradation, photobleaching, or irreversible side reactions.

In some embodiments, read disturb is reduced by selecting a read stimulus that remains below a transition threshold and by limiting the total read exposure. In some embodiments, readout uses low-intensity optical probes, low-voltage electrical probes, short-duration pulses, time-gated sampling, spectrally selective probing, or differential comparison between multiple sensing channels. In some embodiments, the controller tracks cumulative read exposure and compensates for any resulting drift or perturbation. In some embodiments, repeated reads are used with averaging or voting logic to improve confidence while preserving stored-state integrity.

In some embodiments, the disclosed devices are configured to operate in harsh or variable environments. A package can be selected to reduce moisture ingress, oxygen exposure, ionic contamination, ultraviolet exposure, particle contamination, vibration, shock, or mechanical flexing. In some embodiments, the package includes barrier coatings, hermetic layers, getter materials, compliant layers, thermal spreaders, optical windows, or electromagnetic shielding. In some embodiments, environmental protection is selected as part of the barrier-engineering strategy because unwanted environmental coupling can alter an otherwise suitable switching barrier or state preference.

In some embodiments, the disclosed devices are integrated with sensing functions. A local environment can influence the effective switching barrier, the preferred state, the decay rate, or the readout signature of a storage element. In such embodiments, the device can be operated so that an environmental event is stored as a persistent or semi-persistent state change. For example, exposure to heat, light, pressure, strain, magnetic field, chemical analytes, or radiation can be encoded into a state that is later read out. In some embodiments, the sensor-integrated device is used as an event logger, exposure dosimeter, tamper indicator, or condition-history recorder.

In some embodiments, the disclosed devices are integrated with photonic systems. A storage element can modulate absorption, emission, transmission, phase, polarization, resonance condition, or refractive index in a photonic path. In some embodiments, a stored state determines whether light is transmitted, blocked, redirected, phase shifted, or spectrally altered. In some embodiments, the same photonic structure is used for both actuation and readout. In some embodiments, the disclosed barrier-selection framework is used to choose a material or confinement structure that yields a desired optical switching threshold and retention interval.

In some embodiments, the disclosed devices are integrated with computing architectures that use non-binary or analog storage. A storage element can be programmed to one of multiple partial states or can relax in a controlled manner over time. In some embodiments, the stored value represents a weight, confidence level, decay constant, or analog control state. In some embodiments, the barrier regime is selected to give a desired tradeoff between programmability and persistence. In some embodiments, a controller updates the analog state through repeated small programming operations and uses readback verification to keep the stored value within a target window.

In some embodiments, one or more disclosed relations are implemented in a controller, design tool, or fabrication tool as lookup tables rather than by direct real-time computation. For example, target barriers, cascade indices, wavelength recommendations, threshold recommendations, retention estimates, and acceptable tolerance bands can be stored in tabulated form for selected device classes and environmental conditions. In some embodiments, such tabulation reduces computation burden and supports rapid deployment in embedded systems. In some embodiments, the tables are updated over time as measured data accumulates.

In some embodiments, the disclosed framework supports a family of products sharing a common design methodology but differing in materials, operating conditions, and retention classes. For example, a first product can be optimized for low-energy optical switching, a second for non-volatile electrical memory, a third for thermal buffering, and a fourth for environmental event logging. Although these products may use different active materials and packaging, each can be designed by selecting a target barrier regime, identifying a corresponding operating point, and tuning material and structural variables to realize the intended behavior. This common design spine can simplify development across multiple product lines.

It should be understood that the equations and design relations disclosed herein can be used in exact form, approximate form, empirically corrected form, calibration-adjusted form, normalized form, dimensionless form, unit-converted form, or implementation-specific form. In some embodiments, a relation is used only to define a ranking or ordering among candidate designs rather than to provide an exact numerical prediction. In some embodiments, a relation is used together with experimentally measured constants or correction factors. The disclosure is therefore not limited to any single computational formalism so long as a target barrier regime is used to guide material, device, system, or operational selection.

It should also be understood that reference to a first state and a second state does not exclude embodiments in which more than two accessible or useful states are present, nor does reference to a barrier exclude embodiments in which the transition proceeds through multiple sub-barriers, distributed barriers, intermediate wells, cooperative transitions, or ensemble-averaged pathways. Likewise, a storage element can be a single physical unit, a repeated subunit, a distributed region, or an ensemble whose aggregate behavior defines the effective stored state. The disclosure therefore extends to devices and systems in which the operative state transition is realized at different spatial scales and by different microscopic mechanisms.

Unless clearly indicated otherwise, features described in connection with one embodiment can be used in other embodiments, and disclosed methods can be performed in different orders or with repeated, omitted, or substituted operations. Numerical examples, material examples, and architecture examples are provided to illustrate principles of design and operation and are not intended to confine the claims to any specific example unless expressly recited. The scope of the present disclosure is therefore defined by the claims and includes equivalents, modifications, combinations, and subcombinations consistent with the present disclosure.

In some embodiments, the disclosed framework is applied to a molecular ensemble rather than to an isolated molecular unit. A plurality of switchable molecules can be distributed within a host material, arranged in a self-assembled layer, tethered to a surface, embedded in a polymer matrix, confined in pores, or otherwise organized so that ensemble behavior produces a measurable stored state. In some embodiments, ensemble averaging improves readout signal strength, manufacturability, or environmental robustness. In some embodiments, intermolecular coupling, local packing, dipole interactions, or host-guest interactions alter the effective switching barrier relative to that of an isolated molecule, and such effects are treated as part of the barrier-engineering process.

In some embodiments, molecular ensembles are tuned by changing concentration, intermolecular spacing, matrix rigidity, matrix polarity, crosslink density, solvent content, host crystallinity, host porosity, or interfacial chemistry. In some embodiments, the resulting change in local environment shifts the relative stability of the first state and second state or changes the accessibility of the state transition. In some embodiments, a designer intentionally uses such environmental tuning to move a candidate material into a desired retention or write-energy regime without changing the core molecular scaffold.

In some embodiments, polymeric embodiments use chain structure, repeat-unit identity, side-group identity, molecular weight, tacticity, crystallinity, crosslink density, plasticizer content, or blend composition as tuning variables for the effective switching barrier. A polymer can itself define the active switching medium, or it can act as a host for molecular, nanoparticle, ionic, or defect-based active species. In some embodiments, the polymeric embodiment is flexible, stretchable, printable, or conformable. In some embodiments, the polymeric embodiment is packaged in a rigid enclosure. In some embodiments, polymer selection is driven by both barrier engineering and practical considerations such as solvent compatibility, substrate adhesion, mechanical durability, and environmental resistance.

In some embodiments, crystalline or partially crystalline embodiments use crystal symmetry, lattice parameter, phase fraction, grain size, domain size, defect density, or preferred orientation as design variables. In some embodiments, a first state corresponds to a first crystal arrangement and a second state corresponds to a second crystal arrangement or to an amorphous arrangement. In some embodiments, a partial phase fraction is used to encode intermediate or analog states. In some embodiments, phase fractions are stabilized or driven using a combination of electrical, thermal, optical, mechanical, or compositional control.

In some embodiments, amorphous or glassy embodiments are selected where disorder assists in forming metastable occupancy states, broadens acceptable processing windows, or improves device uniformity over large areas. In some embodiments, the effective switching barrier of an amorphous embodiment is tuned by composition, local bonding environment, free volume, defect population, trapped charge, thermal history, or post-deposition conditioning. In some embodiments, the disclosed framework is used to select an amorphous composition that exhibits a target relaxation time, write threshold, or release profile at an intended operating temperature.

In some embodiments, electrochemical embodiments use a reversible or partially reversible change in oxidation state, ion distribution, ion occupancy, coordination environment, or chemical potential to define first and second states. A write stimulus can include an applied potential, current, ion injection, ion extraction, electrolyte exposure, or redox-active optical stimulus. A read stimulus can include open-circuit voltage measurement, current response measurement, impedance measurement, spectroscopic readout, or another state-indicative measurement. In some embodiments, an electrochemical barrier or apparent activation barrier is selected according to the disclosed framework to achieve a desired retention and actuation profile.

In some embodiments, magnetic or spin-sensitive embodiments use a change in magnetic ordering, spin state, anisotropy condition, or spin-crossover configuration as the stored state. A write stimulus can include magnetic field application, spin-polarized current injection, thermal assistance, optical pumping, or pressure tuning. A read stimulus can include magnetoresistive sensing, optical magnetic sensing, inductive sensing, or another magnetic-state-sensitive readout. In some embodiments, the magnetic or spin-sensitive embodiment is selected for non-volatility, fast readout, resistance to photonic disturbance, or compatibility with a larger electronic system.

In some embodiments, ferroelectric or polarization-based embodiments use a reorientable polarization state or domain state as the stored condition. A first polarization orientation and a second polarization orientation can define first and second states separated by an effective switching barrier. In some embodiments, the barrier is tuned by thickness, electrode choice, strain state, defect content, interface condition, dopant content, or temperature window. In some embodiments, such embodiments are attractive for low-energy switching or for compatibility with integrated circuit processes.

In some embodiments, the disclosed framework is used to engineer devices for controlled energy release rather than only for state retention. A storage element can be charged into a higher-energy or loaded condition and then caused to release stored energy in a selected manner when an actuation condition is met. In some embodiments, release is abrupt. In some embodiments, release is graded or time-distributed. In some embodiments, the effective barrier is selected so that release occurs at a target threshold temperature, field, wavelength, mechanical load, or chemical exposure level. In some embodiments, this allows the device to function as a thermal buffer, triggerable release medium, environmental safety element, or condition-responsive actuator.

In some embodiments, the disclosed framework is used to engineer a target release temperature according to an intended application. For example, a thermal-storage medium can be selected to load energy at a first temperature and release useful energy around a second temperature. In some embodiments, the barrier or phase-transition window is selected so that the storage medium remains charged during transport or idle periods but releases energy efficiently when coupled to a thermal load. In some embodiments, this is useful in electronics, buildings, battery systems, clothing, medical transport, food transport, or industrial process management.

In some embodiments, the disclosed framework is used to engineer a target optical threshold. A material, molecule, film, or photonic structure can be selected so that a selected write wavelength, wavelength band, pulse duration, or fluence is sufficient to induce a stored-state change. In some embodiments, the same or a different optical condition is used for readout. In some embodiments, a photonic cavity, plasmonic structure, resonator, waveguide, or metasurface is added to sharpen optical selectivity, increase local field strength, reduce required source power, or improve spatial resolution.

In some embodiments, the disclosed framework is used to engineer a target electrical threshold. A material, contact geometry, local heater geometry, active volume, interface structure, or selector configuration can be chosen so that an effective threshold voltage or threshold current falls within a practical window for a target application. In some embodiments, an array product is designed around a supply voltage constraint, and the active storage element is selected so that reliable switching can be achieved within that supply window. In some embodiments, a write threshold is intentionally increased to improve disturbance immunity, and the controller compensates by using shaped pulses or local heating assistance.

In some embodiments, the disclosed framework is used to engineer a target switching-time regime. A storage element can be selected for sub-nanosecond, nanosecond, microsecond, millisecond, second-scale, or longer-timescale switching depending on the intended application. In some embodiments, rapid switching is favored for active memory or routing applications. In some embodiments, slower controlled release is favored for thermal-buffer or exposure-logging applications. In some embodiments, the same material family can be tuned into different switching-time classes by changing geometry, environment, coupling, or operating conditions.

In some embodiments, the disclosed framework is used to engineer a target cycling regime. A first product class can prioritize maximum cycle life, a second can prioritize long retention, and a third can prioritize minimal write energy. Different barrier regimes, actuation protocols, packaging approaches, and active materials can be selected accordingly. In some embodiments, a controller monitors endurance indicators and transitions a storage element to a different usage mode, refresh schedule, or operating threshold as cycling accumulates.

In some embodiments, the disclosed systems include error-mitigation logic. A state determination can include confidence scoring, repeated sampling, threshold margin comparison, neighboring-cell comparison, parity logic, or error-correcting code support. In some embodiments, a controller chooses to refresh, reprogram, or retire a storage element if confidence in the stored state falls below a threshold. In some embodiments, confidence scoring is based on read amplitude, spectral contrast, timing response, thermal signature, or historical stability.

In some embodiments, calibration is performed once at manufacture. In some embodiments, calibration is performed repeatedly during use. In some embodiments, calibration uses one or more known test states, known pulse sequences, known wavelengths, known temperatures, or known environmental conditions. In some embodiments, calibration produces a mapping between nominal design values and actual device behavior. In some embodiments, the resulting calibration data is stored locally in the device. In some embodiments, the calibration data is stored remotely and retrieved through a networked controller.

In some embodiments, the disclosed framework is applied to distributed systems in which multiple devices or modules share calibration, classification, or operating information. A central or distributed controller can aggregate measured threshold drift, retention drift, environment history, or failure data from many devices and use that information to improve material selection, operating policy, or fabrication recipes for future devices. In some embodiments, field-deployed systems therefore contribute data back into the design workflow shown in FIG. 2, creating a closed development loop spanning fabrication and deployment.

In some embodiments, device selection for a particular application includes consideration of size scale. A nanoscale implementation may offer high density and low actuation energy, whereas a macroscale implementation may offer larger absolute energy capacity or easier packaging. The disclosed barrier-engineering framework can be used across these scales because the selected target barrier or target operating regime is used as the common design anchor even when the physical realization differs substantially.

In some embodiments, the disclosed framework supports hierarchical architectures in which a first barrier-controlled element is coupled to a second barrier-controlled element. For example, a first storage region can provide fast volatile buffering and a second storage region can provide slower but longer-term retention. In some embodiments, a first element provides sensing and a second element provides persistent logging. In some embodiments, a first element provides a trigger and a second element provides stored energy release. Such hierarchical arrangements can be implemented within a common package, module, or controller domain.

In some embodiments, a device or system disclosed herein is used in a safety-related function. A barrier-engineered element can store evidence of an over-temperature event, over-current event, light exposure event, tamper event, mechanical shock event, radiation event, or chemical exposure event. In some embodiments, once the event occurs, the element transitions into a detectable state that persists long enough for inspection or intervention. In some embodiments, this functionality is combined with memory or control capability in the same device.

In some embodiments, the disclosed framework supports manufacture-aware claim scope because device classes, material classes, operating classes, and controller-assisted implementations are all expressly contemplated. A given commercial product may realize only a subset of the disclosed possibilities, but the present disclosure is intended to support devices, systems, and methods in which the principal design step is the selection or realization of a target switching barrier or target transition regime associated with a selected operating function.

The disclosed embodiments can therefore be understood as spanning, without limitation, single storage cells, repeated cells, arrays, modules, thermal packages, optical systems, controller-based systems, design engines, fabrication methods, calibration methods, operating methods, and hybrid combinations thereof. The disclosure also spans a range of active material types including molecular, polymeric, crystalline, amorphous, doped, defect-engineered, nanoparticle, quantum-confined, ferroelectric, magnetic, electrochemical, and hybrid materials, each of which can be selected or tuned according to the disclosed barrier-engineering framework.

While certain embodiments have been described with reference to particular examples, equations, structures, and operating concepts, those examples are illustrative rather than limiting. Different constants, correction terms, tolerances, unit systems, mappings, material-selection criteria, and control strategies can be used without departing from the central disclosure of designing and operating a storage or release element by selecting, approximating, or realizing a target barrier regime associated with an intended function. Accordingly, the present disclosure encompasses variations and equivalents consistent with the claims that follow.

In some embodiments, the disclosed framework is applied during pre-screening of candidate molecules by identifying substituent patterns expected to shift an effective switching barrier toward a selected target regime. Electron-donating groups, electron-withdrawing groups, sterically bulky groups, conjugation-extending groups, crosslinkable groups, anchoring groups, and host-compatible groups can be selected individually or in combination to tune state stability, state accessibility, optical coupling, electrical coupling, or environmental robustness. In some embodiments, substituent effects are evaluated computationally before synthesis. In some embodiments, substituent effects are evaluated empirically by synthesizing a family of related candidates and ranking the resulting candidates based on measured barrier-associated behavior.

In some embodiments, a molecular candidate is accepted for further device integration when measured switching behavior, retention behavior, and readout contrast each fall within selected tolerances for an intended operating class. In some embodiments, candidate molecules are screened by preparing a family of related structures differing in substituent identity, linker chemistry, host environment, or packing condition and then measuring optical response, electrical response, or state-decay behavior under a common operating protocol. In some embodiments, a first subset of the screened molecules is classified for volatile or semi-volatile operation, a second subset is classified for non-volatile operation, and a third subset is classified for event-recording, analog-state, or thermal-response applications. In some embodiments, molecules that do not satisfy a preferred nominal target are retained as fallback candidates for adjacent operating regimes rather than discarded.

In some embodiments, the disclosed framework is applied during film engineering by adjusting deposition rate, chamber pressure, substrate temperature, precursor ratio, post-deposition anneal conditions, quench rate, oxygen content, sulfur content, selenium content, tellurium content, dopant fraction, or interfacial composition. Such variables can influence defect content, grain structure, phase fraction, local bonding environment, and thermal transport, all of which can shift the effective switching barrier of a film-based device. In some embodiments, a target barrier regime is achieved not by a single variable but by a coordinated recipe including composition, thickness, interface selection, and pulse protocol.

In some embodiments, the disclosed framework is applied to nanoparticle or quantum-confined systems by controlling particle diameter, aspect ratio, shell thickness, ligand density, ligand identity, core composition, shell composition, matrix refractive index, matrix dielectric constant, contact spacing, or local cavity environment. In some embodiments, such variables influence confinement energy, coupling efficiency, radiative behavior, non-radiative loss, and state accessibility. In some embodiments, a plurality of nanoparticle populations is screened, and only those populations exhibiting barrier-associated behavior within a selected tolerance band are incorporated into a device or module.

In some embodiments, the disclosed framework is applied to defect-engineered systems by controlling implantation dose, implantation energy, anneal condition, local strain, neighboring dopant density, trap density, interface state density, or local electric field distribution. In some embodiments, a defect-associated first state and a defect-associated second state are stabilized by packaging and operating conditions that reduce undesired recombination or random perturbation. In some embodiments, the resulting structure is useful for persistent event logging, threshold switching, non-volatile storage, or analog decay-based sensing.

In some embodiments, a material-selection process includes exclusion rules in addition to inclusion rules. A candidate can be excluded because its barrier is too low, too high, overly temperature sensitive, chemically unstable, environmentally fragile, difficult to synthesize, difficult to package, difficult to integrate with electrodes, incompatible with available optical sources, incompatible with available write voltages, or otherwise unsuitable for the intended product. In some embodiments, exclusion rules accelerate development by removing candidates that may be theoretically interesting but commercially impractical.

In some embodiments, a design process includes a first-pass analytical barrier estimate, a second-pass computational materials screening step, a third-pass fabrication step, and a fourth-pass measured validation step. In some embodiments, the analytical estimate is derived from the disclosed barrier-selection framework, the computational step uses density functional theory, molecular modeling, finite-element modeling, thermal modeling, electromagnetic modeling, or statistical modeling, and the validation step uses measured switching, retention, or release data. In some embodiments, a candidate is accepted only when all stages indicate suitability for the intended operating regime.

In some embodiments, the disclosed devices are configured for low-disturb readout by physically separating the principal write pathway from the principal read pathway. For example, a storage element can be written electrically and read optically, written optically and read electrically, written thermally and read spectroscopically, or written electrochemically and read capacitively. In some embodiments, this separation improves endurance or reduces accidental state perturbation during repeated read operations. In some embodiments, dual-modality operation also improves state discrimination because two independent observables can be checked against one another.

In some embodiments, state verification is performed immediately after writing. A write stimulus is applied, a verify read is performed, and the result is compared against a target state signature or target threshold. If the desired state is not achieved, one or more supplemental write operations can be applied. In some embodiments, verify-and-adjust logic reduces over-programming because the write operation can be terminated once the intended state is reached. In some embodiments, such logic also allows the controller to track slow drift in actuation requirements over the lifetime of a device.

In some embodiments, a write operation includes applying an initial write stimulus, performing a verify read, comparing a measured state-indicative parameter to a target condition, and then either terminating the write sequence or applying at least one supplemental write stimulus. In some embodiments, the measured state-indicative parameter comprises resistance, capacitance, optical absorption, optical emission, refractive-index response, thermal response, or magnetic response. In some embodiments, this closed-loop write process reduces overshoot, improves endurance, and compensates for drift in effective switching threshold over device lifetime.

In some embodiments, the verify read applies an acceptance rule such that the write sequence is terminated when a measured state-indicative parameter crosses a decision threshold. For example, for resistive readout the decision threshold can be a resistance ratio R_high/R_low≥R_min (e.g., ≥10× or ≥100× depending on implementation), and for optical readout the decision threshold can be an optical contrast ΔOD≥OD_min or a reflectance ratio ≥K_min. The values R_min, OD_min, or K_min can be stored per cell or per group and updated via calibration.

In some embodiments, a refresh policy is used for devices or storage classes whose retention interval under nominal operating conditions is shorter than the intended data-hold interval or energy-hold interval. The refresh policy can be periodic, event-driven, temperature-triggered, confidence-triggered, or history-triggered. In some embodiments, a controller estimates remaining retention time from stored calibration data and present temperature data and schedules a refresh operation before the state decays below an acceptable confidence threshold. In some embodiments, different elements within the same array or module are refreshed at different rates based on their measured barrier class.

In some embodiments, the disclosed framework supports write minimization strategies in which only elements that require updating are rewritten. In an array implementation, a controller can compare new data to stored data and avoid writing elements already in the desired state. In a thermal or energy-buffer implementation, a controller can selectively charge only subregions that have discharged below a selected threshold. In some embodiments, write minimization improves endurance, reduces power consumption, lowers thermal load, and reduces accumulated drift.

In some embodiments, the disclosed framework supports region-specific tuning within a single device or module. A first region can be fabricated with a first barrier class, a second region with a second barrier class, and a third region with a third barrier class. In some embodiments, the different regions are used for different retention classes, different switching thresholds, different optical thresholds, or different release temperatures. In some embodiments, region-specific tuning is achieved by changing composition, thickness, heater structure, particle loading, local matrix composition, or controller pulse protocols across the different regions.

In some embodiments, the disclosed framework supports graded structures in which a composition, defect density, particle loading, or phase fraction varies continuously or stepwise across a device. Such grading can be used to broaden an operating window, smooth a release profile, shape a thermal response, shape an optical response, or create a preferred write path or erase path. In some embodiments, a graded structure supports controlled partial programming or controlled staged release of stored energy.

In some embodiments, packaging is used not merely for protection but as an active barrier-engineering feature. A package can influence moisture content, gas composition, thermal leakage, optical background, magnetic shielding, mechanical compliance, and chemical exposure, each of which can shift state stability or actuation accessibility. In some embodiments, the package includes one or more active control elements such as heaters, coolers, desiccants, getters, shutters, filters, or sensors that help maintain the storage element within a target operating envelope. In some embodiments, packaging variables are selected along with material variables during design.

In some embodiments, packaging variables are selected to maintain a storage element within a target optical or thermal operating envelope. For example, an optical embodiment can include a window, filter, reflective layer, or shielding layer selected to reduce unwanted background illumination or spectral contamination, and a thermal embodiment can include a thermal spreader, thermal choke, insulation layer, or heat-routing structure selected to reduce uncontrolled heat leakage. In some embodiments, the package thereby contributes directly to preservation of a selected effective switching barrier, retention interval, release profile, or readout margin.

In some embodiments, the disclosed framework is used with modular products that are field-replaceable or field-upgradable. A module can include its own calibration record, barrier classification, and recommended operating parameters stored in local memory or encoded in a machine-readable label. A host system can read the module information and automatically adjust write, read, erase, or charge-discharge behavior. In some embodiments, this allows multiple module types having different active materials or retention classes to be used interchangeably within a common platform.

In some embodiments, the disclosed framework is used to create adaptive products that intentionally change operating policy over lifetime. A product can begin in a high-performance write mode, transition to a reduced-energy mode as it ages, and later enter a conservatively refreshed archival mode or reduced-duty-cycle thermal mode. In some embodiments, such adaptation is based on measured threshold drift, measured leakage, measured optical contrast loss, measured thermal response degradation, or accumulated cycle count. In some embodiments, lifetime adaptation extends useful service life without changing the underlying hardware.

In some embodiments, the disclosed framework supports security or anti-tamper functions. A storage element can be configured so that a targeted environmental challenge, such as elevated temperature, intense light, mechanical intrusion, or chemical exposure, irreversibly or semi-irreversibly changes the stored state. In some embodiments, that change serves as evidence of tampering. In some embodiments, a controller logs the event and changes later operating behavior. In some embodiments, a multi-region device includes one region used for ordinary storage and another region reserved for tamper indication or lifecycle logging.

In some embodiments, the disclosed framework supports authentication or provenance functions. A fabricated population of devices can exhibit slightly different measured barrier signatures, switching fingerprints, spectral responses, or decay profiles. In some embodiments, those measured characteristics are stored as a device fingerprint and later used to authenticate the device or module. In some embodiments, the barrier-engineered nature of the storage element provides a stable but distinctive physical signature useful for anti-counterfeit or supply-chain verification.

In some embodiments, the disclosed framework supports coupled sensing-and-memory functions in which a sensed event directly drives a write transition without requiring substantial intermediate processing. For example, a heat pulse, light pulse, pressure pulse, magnetic event, chemical exposure, or radiation event can directly move an element from a first state to a second state. In some embodiments, the changed state is later read by a separate system. In some embodiments, this allows passive event recording or low-power environmental history logging.

In some embodiments, the disclosed framework supports distributed thermal products in which multiple thermal submodules with different barrier classes are combined. A first submodule can deliver fast release, a second can deliver intermediate retention, and a third can deliver slow release or long hold time. In some embodiments, a controller selectively couples these submodules to a thermal load based on demand. In some embodiments, this layered thermal architecture allows a single package to emulate multiple thermal response timescales.

In some embodiments, the disclosed framework supports mixed digital-and-analog products. A first subset of elements can be used for discrete state storage and a second subset can be used for analog weighting, graded response, or decay-timed functions. In some embodiments, both subsets are fabricated from related materials but operated under different thresholds or pulse protocols. In some embodiments, a common controller manages both subsets while using different read and write policies.

In some embodiments, the disclosed framework supports manufacturing workflows in which the final claimed product is defined not just by material composition but also by barrier-class assignment. Thus, two devices fabricated from nominally similar materials can be assigned to different product categories based on measured effective switching barrier, measured retention behavior, measured write threshold, or measured release profile. In some embodiments, this allows product lines to be defined by functional class as well as by composition.

In some embodiments, the disclosed framework supports design spaces in which a target application is first mapped to a target barrier regime, then to a set of admissible material classes, and then to a narrower set of admissible fabrication recipes. In some embodiments, this three-stage narrowing process is implemented in software. In some embodiments, it is implemented through lookup tables and engineering guidelines. In some embodiments, it is implemented partly by human review and partly by automated screening.

In some embodiments, disclosed methods include preparing a ranked list of candidate implementations for a given specification rather than a single winning candidate. The ranked list can identify primary, secondary, and fallback embodiments having different tradeoffs among retention, switching speed, manufacturability, source compatibility, environmental tolerance, and cost. In some embodiments, this ranked-list approach improves development resilience because the project can shift to a fallback candidate if the primary candidate proves difficult to fabricate or package.

In some embodiments, the present disclosure expressly contemplates that measured real-world behavior may be influenced by interactions not captured in a simple first-pass model, including cooperative transitions, many-body effects, heterogeneous local environments, distributed thermal gradients, non-uniform optical illumination, stochastic defect populations, and device-to-device manufacturing variation. The disclosed barrier-engineering framework remains applicable because it provides a target operating regime and a structured path for mapping that regime onto practical materials and devices, even where a final implementation uses empirically corrected or calibration-adjusted parameters.

In some embodiments, the disclosed framework is used to support cross-platform translation of a target function. A target write energy, retention interval, or release temperature identified for one material class can be translated into an alternative material class when supply chain, fabrication, environmental, or cost constraints change. Thus, a molecular embodiment, a film embodiment, and a thermal composite embodiment can each be designed to satisfy a related functional target even though their microscopic mechanisms differ. This translation capability can be valuable in product migration, redesign, or second-source qualification.

The present disclosure therefore provides a unified approach for selecting, fabricating, tuning, packaging, calibrating, classifying, and operating storage and release devices whose useful behavior depends on a controllable transition barrier. By expressing design intent in terms of a target barrier regime and then realizing that regime through suitable materials, structures, and operating conditions, the disclosed framework supports broad classes of molecular, solid-state, nanoscale, thermal, optical, electrochemical, magnetic, and hybrid products. The foregoing description is intended to provide written description and enablement support for the claims that follow and for equivalents, alternatives, and combinations consistent with the present disclosure.

In some embodiments, the disclosed devices, systems, and methods share a common inventive concept in that a target operating requirement is mapped to a target barrier value or target barrier band, and a storage element and operating protocol are selected, tuned, calibrated, and verified so that a measured effective switching barrier substantially corresponds to the target barrier value or target barrier band and is accepted under an objective acceptance criterion during verify-and-adjust operation. In such embodiments, the disclosed framework provides a common technical design spine across molecular, thin-film, nanoparticle/quantum-confined, doped/defect-engineered, optical, electrical, and thermal implementations.

What is claimed is:

1. A storage device comprising: at least one storage element configured to occupy a first state and a second state, the first state and the second state being separated by an effective switching barrier selected by mapping at least one target performance parameter to a target barrier value or target barrier band associated with at least one of a write condition, a retention behavior, a switching speed, or an energy-release behavior; and a control arrangement configured to apply a write stimulus to the at least one storage element to cause a transition between the first state and the second state, and to perform a verify read by applying a read stimulus selected to determine a present state of the at least one storage element without substantial unintended switching and by comparing at least one measured state-indicative parameter to an acceptance criterion to determine whether the transition has been achieved.

2. The storage device of claim 1, wherein the effective switching barrier substantially corresponds to a target barrier selected according to the relation Delta_E_n=E_coh*X_opt\hat{ }(1-n), where Delta_E_n is the target barrier, E_coh is a coherence-scale energy parameter, X_opt is an optimization parameter, and n is a selected cascade index.

3. The storage device of claim 2, wherein X_opt=phi/pi, where phi=(1+sqrt(5))/2.

4. The storage device of claim 1, wherein the at least one storage element comprises at least one of a molecular switching material, a polymeric storage material, a phase-change thin film, a crystalline-amorphous switching medium, a doped semiconductor region, a defect-engineered lattice region, a nanoparticle ensemble, a quantum-confined structure, a thermal-storage composite, or a hybrid material system.

5. The storage device of claim 1, wherein the control arrangement is further configured to apply a read stimulus selected to determine a present state of the at least one storage element without substantial unintended switching of the at least one storage element.

6. The storage device of claim 1, wherein the write stimulus comprises at least one of an optical stimulus, an electrical stimulus, a thermal stimulus, an electrochemical stimulus, a magnetic stimulus, a mechanical stimulus, or a strain-based stimulus.

7. The storage device of claim 1, wherein the control arrangement is configured to perform verify-and-adjust programming by (i) applying the write stimulus, (ii) performing the verify read, and (iii) when the acceptance criterion is not satisfied, applying at least one supplemental write stimulus until the acceptance criterion is satisfied or a maximum pulse budget is reached.

8. The storage device of claim 1, wherein the at least one storage element is positioned between conductive coupling structures or adjacent to optical, thermal, magnetic, or electrochemical coupling structures configured to deliver the write stimulus to the at least one storage element.

9. The storage device of claim 1, wherein the control arrangement is configured to apply the read stimulus at a level below a write threshold of the at least one storage element and to determine a stored state from at least one measured parameter comprising resistance, capacitance, optical absorption, optical emission, refractive-index response, thermal response, or magnetic response, and to compare the at least one measured parameter to the acceptance criterion to determine whether the stored state satisfies a target operating regime.

10. The storage device of claim 1, wherein the control arrangement is configured to compensate at least one of a write threshold, a read threshold, or a refresh interval based on at least one of temperature variation, drift, cycling history, or environmental exposure.

11. An addressable storage system comprising:
a plurality of storage cells arranged in an addressable architecture, each storage cell including at least one storage element configured to occupy a first state and a second state separated by a corresponding effective switching barrier selected to correspond to a target operating regime; and
a controller configured to select one or more of the storage cells for writing or reading and to apply corresponding operating conditions to the selected one or more storage cells.

12. The addressable storage system of claim 11, further comprising at least one of a selector element, a sense amplifier, a write driver, a row decoder, a column decoder, an optical-routing component, a heating element, a calibration circuit, or an environmental sensor.

13. The addressable storage system of claim 11, wherein the controller is configured to store per-cell or per-group calibration values and to compensate for at least one of threshold drift, retention drift, temperature variation, environmental exposure, or cycling history.

14. The addressable storage system of claim 11, wherein different storage cells in the addressable architecture are configured with different effective switching barriers corresponding to different retention classes, switching thresholds, or operating functions.

15. The addressable storage system of claim 11, wherein the controller is configured to apply a verify read after a write operation and to modify at least one subsequent write condition for a selected storage cell based on a measured state-indicative parameter of the selected storage cell.

16. A method of making a storage device, the method comprising:
selecting at least one target performance parameter;
determining from the at least one target performance parameter a target barrier corresponding to a target operating regime;
selecting a material or structural configuration capable of exhibiting an effective switching barrier corresponding to the target barrier; and
forming a storage element from the selected material or structural configuration so that the storage element is operable to transition between a first state and a second state.

17. The method of claim 16, further comprising determining a target cascade index or target operating point corresponding to the target barrier.

18. The method of claim 16, wherein selecting the material or structural configuration includes selecting at least one of a material class, a composition, a molecular scaffold, a substituent pattern, a film thickness, a confinement dimension, a dopant profile, a defect profile, a matrix environment, an interface structure, a contact geometry, a heater geometry, or an encapsulation strategy.

19. The method of claim 16, further comprising measuring at least one of switching behavior, retention behavior, threshold behavior, optical response, electrical response, thermal response, or structural response of the storage element and adjusting the material or structural configuration based on the measured behavior.

20. The method of claim 16, further comprising measuring at multiple temperatures at least one of switching threshold, retention time, decay rate, optical response, electrical response, or thermal response of the storage element, determining from the measured behavior an effective switching barrier or barrier class, and adjusting at least one material-selection parameter or operating parameter based on the determined effective switching barrier or barrier class.
